(19) United States
(12) Patent Application Publication
(10) Pub. No.: US 2005/0037923 A1
(43) Pub. Date: Feb. 17, 2005

(54) Herbicidal mixture based on 7-pyrazolybenzoxazoles

(75) Inventors: Cyrill Zagar, Mannheim (DE); Bernd Sievernich, Hassloch (DE); Ulrich Schofl, Bruhl (DE); Karl-Otto Westphalen, Speyer (DE); Akihide Watanabe, Minami Ayase-shi (JP); Max Landes, Visalia, CA (US); Andreas Landes, Romerberg-Heiligenstein (DE); Matthias Witschel, Bad Durkheim (DE)

Correspondence Address: KEIL & WEINKAUF, 1350 CONNECTICUT AVENUE, N.W., WASHINGTON, DC, 20036, US

(73) Assignee: BASF Aktiengesellschaft, 67056 Ludwigshafen (DE)

(21) Appl. No.: 10/499,669

(22) PCT Filed: Dec. 18, 2002
(86) PCT No.: PCT/EP02/14485

Related U.S. Application Data
(60) Provisional application No. 60/340,954, filed on Dec. 19, 2001.

(51) Int. Cl. A01N 43/36

(52) U.S. Cl. 504/138

(57) ABSTRACT

Herbicidally active compositions comprising: A) at least one 7-pyrazolylbenzoxazole compound of the formula (I) in which the variables R¹-R⁵ are as defined in the patent claims and/or at least one of its agriculaturally acceptable salts; and at least one further active compound selected from herbicidally active compounds and safeners.

The present invention relates to herbicidally active compositions comprising 7-pyrazolylbenzoxazoles and at least one further active compound selected from herbicidally active compounds and safeners.

In crop protection products, it is desirable in principle to increase the specificity and the reliability of the action of active compounds. In particular, it is desirable for the crop protection product to control the harmful plants effectively and, at the same time, to be tolerated by the useful plants in question.

Various publications have described 7-pyrazolylbenzoxazoles as being highly effective herbicides. However, their compatibility with dicotyledonous crop plants such as cotton, oilseed rape and some graminaceous plants such as barley, millet, corn, rice, wheat and sugar cane is not always satisfactory, i.e. in addition to the harmful plants, the crop plants are also damaged to an extent which is not acceptable. It is possible to spare the useful plants by lowering the application rates; however, the extent of the control of harmful plants is naturally also reduced.

It is known that certain combinations of different herbicides with specific action result in an enhanced activity of a herbicide component by synergism. As a consequence, it is possible to reduce the application rates of herbicidally active compounds required for controlling the harmful plants. Furthermore, it is known that in some cases better crop plant compatibility can be achieved by joint application of specifically acting herbicides with organic active compounds, some of which are themselves herbicidally active. In these cases, the active compounds act as antidote or antagonist, and, owing to the fact that they can reduce or even prevent damage to the crop plants, they are also referred to as safeners.

WO 98/27090 and WO 99/55702 disclose 7-pyrazolylbenzoxazoles of the formula I 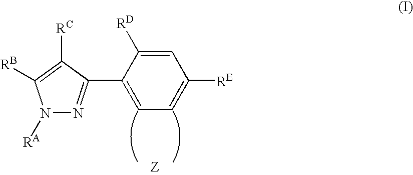
in which the variables R^{A}-R^{E} and Z are as defined below:
R^{A} is hydrogen, C₁-C₄-alkyl or C₁-C₄-haloalkyl;
R^{B} is cyano, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl;
R^{C} is hydrogen, cyano, nitro, halogen, C₁-C₄-alkyl or C₁-C₄-haloalkyl;
R^{D} is halogen or hydrogen;
R^{E} is hydrogen, halogen, cyano, C₁-C₄-alkyl, C₁-C₄-haloalkyl, C₁-C₄-alkoxy or C₁-C₄-haloalkoxy, and
Z together with the phenyl ring to which it is attached forms a benzoxazole ring or a benzothiazole ring which is substituted by various substituents.

However, the herbicidal action of the compounds described therein is unsatisfactory. Furthermore, at higher dosages, their compatibility with useful plants is not always ensured.

It is an object of the present invention to provide herbicidal compositions having increased activity against unwanted harmful plants and at the same time better compatibility with useful plants.

We have found that this object is achieved, surprisingly, by compositions comprising A) at least one 7-pyrazolylbenzoxazole of the formula I 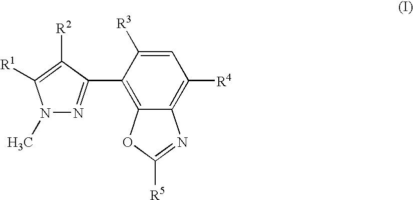
in which the variables R¹-R⁵ are as defined below:
R¹ is difluoromethoxy, trifluoromethyl or methylsulfonyl;
R² is halogen;
R³ is hydrogen or halogen;
R⁴ is halogen or cyano;
R⁵ is hydrogen, C₁-C₆-alkyl, C₁-C₆-haloalkyl, C₃-C₆-alkenyl, cyano-C₃-C₆-alkenyl, C₃-C₆-haloalkenyl, C₃-C₆-alkynyl, cyano-C₃-C₆-alkynyl, C₃-C₆-haloalkynyl,
   C₁-C₄-alkyl which carries one of the following groups: cyano, hydroxyl, carboxyl, C₁-C₄-alkoxy, C₁-C₄-haloalkoxy, C₃-C₄-alkenyloxy, C₃-C₄-alkynyloxy, C₃-C₈-cycloalkyl, C₃-C₈-cycloalkyloxy, amino, C₁-C₄-alkylamino, di(C₁-C₄-alkyl)amino, C₁-C₄-alkylthio, C₁-C₄-haloalkylthio, C₃-C₄-alkenylthio, C₃-C₄-alkynylthio, C₁-C₄-alkylsulfinyl, C₁-C₄-haloalkylsulfinyl, C₃-C₄-alkenylsulfinyl, C₃-C₄-alkynylsulfinyl, C₁-C₄-alkylsulfonyl, C₁-C₄-haloalkylsulfonyl, C₃-C₄-alkenylsulfonyl, C₃-C₄-alkynylsulfonyl, (C₁-C₄-alkoxy)carbonyl, C₃-C₈-cycloalkyl, phenyl;
   phenyl, C₃-C₈-cycloalkyl, where each cycloalkyl or phenyl ring may be unsubstituted or may carry one, two, three or four substituents independently of one another selected from the group consisting of cyano, nitro, amino, hydroxyl, carboxyl, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, (C₁-C₄-alkoxy)carbonyl, (C₁-C₄-alkyl)carbonyl, (C₁-C₄-haloalkyl)carbonyl, (C₁-C₄-alkyl)carbonyloxy, (C₁-C₄-haloalkyl)carbonyloxy and di(C₁-C₄-alkyl)amino;
and/or at least one agriculturally acceptable salt of I; and at least one further active compound selected from
B) herbicides of classes b1) to b15):
   b1) lipid biosynthesis inhibitors;
   b2) acetolactate synthase inhibibitors (ALS inhibitors);
   b3) photosynthesis inhibitors;
   b4) protoporphyrinogen-IX oxidase inhibitors,
   b5) bleacher herbicides;
   b6) enolpyruvyl shikimate 3-phosphate synthase inhibitors (EPSP inhibitors);
   b7) glutamine synthetase inhibitors;
   b8) 7,8-dihydropteroate synthase inhibitors (DHP inhibitors);
   b9) mitose inhibitors;
   b10) inhibitors of the synthesis of long-chain fatty acids (VLCFA inhibitors);
   b11) cellulose biosynthesis inhibitors;
   b12) decoupler herbicides;
   b13) auxin herbicides;
   b14) auxin transport inhibitors;
   b15) other herbicides selected from the group consisting of benzoylprop, flamprop, flamprop-M, bromobutide, chlorflurenol, cinmethylin, methyldymron, etobenzanid, fosamine, metam, pyributicarb, oxaziclomefone, dazomet, triaziflam, methyl bromide, daimuron (dymron) and cumyluron;
      and
C) safeners selected from: benoxacor, cloquintocet, cyometrinil, dichlormid, dicyclonon, dietholate, fenchlorazole, fenclorim, flurazole, fluxofenim, furilazole, isoxadifen, mefenpyr, mephenate, napthalic anhydride, 2,2,5-trimethyl-3-(dichloroacetyl)-1,3-oxazolidine (R-29148), 4-(dichloroacetyl)-1-oxa-4-azaspiro[4.5]decane (AD-67; MON 4660) and oxabetrinil;
   the agriculturally acceptable salts of the active compounds B and C and the agriculturally acceptable derivatives of the active compounds B and C, provided they have a carboxyl group.

The invention relates in particular to compositions in the form of herbicidally active crop protection compositions comprising a herbicidally effective amount of at least one mixture of A with B and/or C, as defined above, and at least one liquid and/or solid carrier, if desired, one or more surfactants and, if desired, one or more further auxiliaries customary for crop protection compositions. The invention also relates to compositions in the form of a crop protection composition formulated as a 2-component composition comprising a first component which comprises the active compound A, a solid or liquid carrier and, if appropriate, one or more surfactants, and a second component which comprises at least one further active compound selected from the herbicides B and the safeners C, a solid or liquid carrier and, if appropriate, one or more surfactants, where both components may additionally also comprise further auxiliaries customary for crop protection compositions.

Compositions according to the invention which comprise both at least one 7-pyrazolylbenzoxazole of the formula I and at least one herbicide-B surprisingly have better herbicidal activity, i.e. better action against harmful plants, than would have been expected based on the herbicidal action observed for the individual compounds. Compositions comprising a 7-pyrazolylbenzoxazole I, a herbicide B and one of the compounds mentioned under C likewise have better herbicidal action against harmful plants than would have been expected based on the herbicidal activity of the individual compounds. The herbicidal action to be expected, based on the individual compounds, for the mixtures can be calculated using Colby's formula (see below). If the observed activity exceeds the expected additive activity of the individual compounds, this is referred to as synergism.

Compositions according to the invention comprising both at least one 7-pyrazolylbenzoxazole of the formula I and at least one of the compounds listed under C show, with comparable herbicidal action, better compatibility with useful plants than a composition comprising the 7-pyrazolylbenzoxazole I on its own. This also applies, in a similar manner, to compositions comprising a 7-pyrazolylbenzoxazole I, a herbicide B and one of the compounds mentioned under C, compared to compositions comprising only a 7-pyrazolylbenzoxazole I and a herbicide B.

The invention furthermore relates to a method for controlling undesirable vegetation, in particular in crops of cereals, corn, soybeans, rice, oilseed rape, cotton, potatoes, groundnuts or in perennial crops, and also in crops which, by genetic engineering or by breeding, are resistant to one or more herbicides or to attack by insects. The invention also relates to a method for the desiccation or defoliation of plants. In the latter methods it is immaterial whether the herbicidally active compounds of components A) and B) and/or C) are formulated and applied jointly or separately, and, in the case of separate application, in which order the application takes place.

The organic moieties mentioned in the definition of the substituents R² to R⁵ in formula I and R⁶ to R¹⁸ in the formulae II and III below or as radicals on cycloalkyl, phenyl or heterocyclic rings are—like the term halogen—collective terms for individual enumerations of the individual group members. All carbon chains, i.e. all alkyl, haloalkyl, cycloalkyl, alkoxy, haloalkoxy, alkylamino, alkylthio, haloalkylthio, alkylsulfinyl, haloalkylsulfinyl, alkylsulfonyl, haloalkylsulfonyl, alkenyl and alkynyl groups and corresponding moieties in larger groups such as alkylcarbonyl, alkoxycarbonyl, etc., can be straight-chain or branched, the prefix Cₙ-Cₘ denoting in each case the possible number of carbon atoms in the group. Halogenated substituents preferably carry one, two, three, four or five identical or different halogen atoms.

Specifically, the radicals have, for example, the following meanings:
halogen: fluorine, chlorine, bromine, iodine, preferably fluorine, chlorine or bromine;
C₁-C₄-alkyl: CH₃, C₂H₅, n-propyl, CH(CH₃)₂, n-butyl, CH(CH₃)—C₂H₅, CH₂—CH(CH₃)₂ and C(CH₃)₃;
C₁-C₄-haloalkyl: a C₁-C₄-alkyl radical as mentioned above which is partially or fully substituted by fluorine, chlorine, bromine and/or iodine, i.e., for example, CH₂F, CHF₂, CF₃, CH₂Cl, dichloromethyl, trichloromethyl, chlorofluoromethyl, dichlorofluoromethyl, chlorodifluoromethyl, 2-fluoroethyl, 2-chloroethyl, 2-bromoethyl, 2-iodoethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, C₂F₅, 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromomethyl)-2-bromoethyl, 4-fluorobutyl, 4-chlorobutyl, 4-bromobutyl or nonafluorobutyl;
C₁-C₆-alkyl: C₁-C₄-alkyl as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl;
C₁-C₆-haloalkyl: a C₁-C₆-alkyl radical as mentioned above which is partially or fully substituted by fluorine, chlorine, bromine and/or iodine, i.e., for example, one of the radicals mentioned under C₁-C₄-haloalkyl and also 5-fluoro-1-pentyl, 5-chloro-1-pentyl, 5-bromo-1-pentyl, 5-iodo-1-pentyl, 5,5,5-trichloro-1-pentyl, undecafluoropentyl, 6-fluoro-1-hexyl, 6-chloro-1-hexyl, 6-bromo-1-hexyl, 6-iodo-1-hexyl, 6,6,6-trichloro-1-hexyl or dodecafluorohexyl;
C₁-C₄-alkoxy: OCH₃, OC₂H₅, n-propoxy, OCH(CH₃)₂, n-butoxy, OCH(CH₃)—C₂H₅, OCH₂—CH(CH₃)₂ or OC(CH₃)₃, preferably OCH₃, OC₂H₅ or OCH(CH₃)₂;
C₁-C₄-haloalkoxy: a C₁-C₄-alkoxy radical as mentioned above which is partially or fully substituted by fluorine, chlorine, bromine and/or iodine, i.e., for example, OCH₂F, OCHF₂, OCF₃, OCH₂Cl, OCH(Cl)₂, OC(Cl)₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, OC₂F₅, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, 2,2,3,3,3-pentafluoropropoxy, OCF₂—C₂F₅, 1-(CH₂F)-2-fluoroethoxy, 1-(CH₂Cl)-2-chloroethoxy, 1-(CH₂Br)-2-bromoethoxy, 4-fluorobutoxy, 4-chlorobutoxy, 4-bromobutoxy or nonafluorobutoxy, preferably OCHF₂, OCF₃, dichlorofluoromethoxy, chlorodifluoromethoxy or 2,2,2-trifluoroethoxy;
C₁-C₄-alkylamino: NH(CH₃), NH(C₂H₅), propylamino, NH[CH(CH₃)₂], butylamino, 1-methylpropylamino, 2-methylpropylamino, NH[C(CH₃)₃];
di(C₁-C₄-alkyl)amino: N(CH₃)₂, N(C₂H₅)₂, N,N-dipropylamino, N[CH(CH₃)₂]₂, N,N-dibutylamino, N,N-di(1-methylpropyl)amino, N,N-di(2-methylpropyl)amino, N[C(CH₃)₃]₂, N-ethyl-N-methylamino, N-methyl-N-propylamino, N-methyl-N-(1-methylethyl)amino, N-butyl-N-methylamino, N-methyl-N-(1-methylpropyl)amino, N-methyl-N-(2-methylpropyl)amino, N-(1,1-dimethylethyl)-N-methylamino, N-ethyl-N-propylamino, N-ethyl-N-(1-methylethyl)amino, N-butyl-N-ethylamino, N-ethyl-N-(1-methylpropyl)amino, N-ethyl-N-(2-methylpropyl)amino, N-ethyl-N-(1,1-dimethylethyl)amino, N-(1-methylethyl)-N-propylamino, N-butyl-N-propylamino, N-(1-methylpropyl)-N-propylamino, N-(2-methylpropyl)-N-propylamino, N-(1,1-dimethylethyl)-N-propylamino, N-butyl-N-(1-methylethyl)amino, N-(1-methylethyl)-N-(1-methylpropyl)amino, N-(1-methylethyl)-N-(2-methylpropyl)amino, N-(1,1-dimethylethyl)-N-(1-methylethyl)amino, N-butyl-N-(1-methylpropyl)amino, N-butyl-N-(2-methylpropyl)amino, N-butyl-N-(1,1-dimethylethyl)amino, N-(1-methylpropyl)-N-(2-methylpropyl)amino, N-(1,1-dimethylethyl)-N-(1-methylpropyl)amino or N-(1,1-dimethylethyl)-N-(2-methylpropyl)amino, preferably N(CH₃)₂ or N(C₂H₅);
C₁-C₄-alkylthio: SCH₃, SC₂H₅, n-propylthio, SCH(CH₃)₂, n-butylthio, SCH(CH₃)—C₂H₅, SCH₂—CH(CH₃)₂ or SC(CH₃)₃, preferably SCH₃ or SC₂H₅;
C₁-C₄-haloalkylthio: a C₁-C₄-alkylthio radical as mentioned above which is partially or fully substituted by fluorine, chlorine, bromine and/or iodine, i.e., for example, SCH₂F, SCHF₂, SCH₂Cl, SCH(Cl)₂, SC(Cl)₃, SCF₃, chlorofluoromethylthio, dichlorofluoromethylthio, chlorodifluoromethylthio, 2-fluoroethylthio, 2-chloroethylthio, 2-bromoethylthio, 2-iodoethylthio, 2,2-difluoroethylthio, 2,2,2-trifluoroethylthio, 2-chloro-2-fluoroethylthio, 2-chloro-2,2-difluoroethylthio, 2,2-dichloro-2-fluoroethylthio, 2,2,2-trichloroethylthio, SC₂F₅, 2-fluoropropylthio, 3-fluoropropylthio, 2,2-difluoropropylthio, 2,3-difluoropropylthio, 2-chloropropylthio, 3-chloropropylthio, 2,3-dichloropropylthio, 2-bromopropylthio, 3-bromopropylthio, 3,3,3-trifluoropropylthio, 3,3,3-trichloropropylthio, SCH₂—C₂F₅, SCF₂—C₂F₅, 1-(CH₂F)-2-fluoroethylthio, 1-(CH₂Cl)-2-chloroethylthio, 1-(CH₂Br)-2-bromoethylthio, 4-fluorobutylthio, 4-chlorobutylthio, 4-bromobutylthio or SCF₂—CF₂—C₂F₅, preferably SCHF₂, SCF₃, dichlorofluoromethylthio, chlorodifluoromethylthio or 2,2,2-trifluoroethylthio;
C₁-C₄-alkylsulfinyl: SO—CH₃, SO—C₂H₅, SO—CH₂—C₂H₅, SO—CH(CH₃)₂, n-butylsulfinyl, SO—CH(CH₃)—C₂H₅, SO—CH₂—CH(CH₃)₂ or SO—C(CH₃)₃, preferably SO—CH₃ or SO—C₂H₅;
C₁-C₄-haloalkylsulfinyl: a C₁-C₄-alkylsulfinyl radical—as mentioned above—which is partially or fully substituted by fluorine, chlorine, bromine and/or iodine, i.e., for example, SO—CH₂F, SO—CHF₂, SO—CF₃, SO—CH₂Cl, SO—CH(Cl)₂, SO—C(Cl)₃, chlorofluoromethylsulfinyl, dichlorofluoromethylsulfinyl, chlorodifluoromethylsulfinyl, 2-fluoroethylsulfinyl, 2-chloroethylsulfinyl, 2-bromoethylsulfinyl, 2-iodoethylsulfinyl, 2,2-difluoroethylsulfinyl, 2,2,2-trifluoroethylsulfinyl, 2-chloro-2-fluoroethylsulfinyl, 2-chloro-2,2-difluoroethylsulfinyl, 2,2-dichloro-2-fluoroethylsulfinyl, 2,2,2-trichloroethylsulfinyl, SO—C₂F₅, 2-fluoropropylsulfinyl, 3-fluoropropylsulfinyl, 2,2-difluoropropylsulfinyl, 2,3-difluoropropylsulfinyl, 2-chloropropylsulfinyl, 3-chloropropylsulfinyl, 2,3-dichloropropylsulfinyl, 2-bromopropylsulfinyl, 3-bromopropylsulfinyl, 3,3,3-trifluoropropylsulfinyl, 3,3,3-trichloropropylsulfinyl, SO—CH₂—C₂Fs, SO—CF₂—C₂F₅, 1-(fluoromethyl)-2-fluoroethylsulfinyl, 1-(chloromethyl)-2-chloroethylsulfinyl, 1-(bromomethyl)-2-bromoethylsulfinyl, 4-fluorobutylsulfinyl, 4-chlorobutylsulfinyl, 4-bromobutylsulfinyl or nonafluorobutylsulfinyl, preferably SO—CF₃, SO—CH₂Cl or 2,2,2-trifluoroethylsulfinyl;
C₁-C₄-alkylsulfonyl: SO₂—CH₃, SO₂—C₂H₅, SO₂—CH₂—C₂H₅, SO₂—CH(CH₃)₂, n-butylsulfonyl, SO₂—CH(CH₃)—C₂H₅, SO₂—CH₂—CH(CH₃)₂ or SO₂—C(CH₃)₃, preferably SO₂—CH₃ or SO₂—C₂H₅;
C₁-C₄-haloalkylsulfonyl: a C₁-C₄-alkylsulfonyl radical—as mentioned above—which is partially or fully substituted by fluorine, chlorine, bromine and/or iodine, i.e., for example, SO₂—CH₂F, SO₂—CHF₂, SO₂—CF₃, SO₂—CH₂Cl, SO₂—CH(Cl)₂, SO₂—C(Cl)₃, chlorofluoromethylsulfonyl, dichlorofluoromethylsulfonyl, chlorodifluoromethylsulfonyl, 2-fluoroethylsulfonyl, 2-chloroethylsulfonyl, 2-bromoethylsulfonyl, 2-iodoethylsulfonyl, 2,2-difluoroethylsulfonyl, 2,2,2-trifluoroethylsulfonyl, 2-chloro-2-fluoroethylsulfonyl, 2-chloro-2,2-difluoroethylsulfonyl, 2,2-dichloro-2-fluoroethylsulfonyl, 2,2,2-trichloroethylsulfonyl, SO₂—C₂F₅, 2-fluoropropylsulfonyl, 3-fluoropropylsulfonyl, 2,2-difluoropropylsulfonyl, 2,3-difluoropropylsulfonyl, 2-chloropropylsulfonyl, 3-chloropropylsulfonyl, 2,3-dichloropropylsulfonyl, 2-bromopropylsulfonyl, 3-bromopropylsulfonyl, 3,3,3-trifluoropropylsulfonyl, 3,3,3-trichloropropylsulfonyl, SO₂—CH₂—C₂F₅, SO₂—CF₂—C₂F₅, 1-(fluoromethyl)-2-fluoroethylsulfonyl, 1-(chloromethyl)-2-chloroethylsulfonyl, 1-(bromomethyl)-2-bromoethylsulfonyl, 4-fluorobutylsulfonyl, 4-chlorobutylsulfonyl, 4-bromobutylsulfonyl or nonafluorobutylsulfonyl, preferably SO₂—CF₃, SO₂—CH₂Cl or 2,2,2-trifluoroethylsulfonyl;
C₁-C₄-alkylaminocarbonyl: methylaminocarbonyl, ethylaminocarbonyl, 1-methylethylaminocarbonyl, propylaminocarbonyl, butylaminocarbonyl, 1-methylpropylaminocarbonyl, 2-methylpropylaminocarbonyl, 1,1-dimethylethylaminocarbonyl;
di(C₁-C₄-alkyl)aminocarbonyl: N,N-dimethylaminocarbonyl, N,N-diethylaminocarbonyl, N,N-di(1-methylethyl)aminocarbonyl, N,N-dipropylaminocarbonyl, N,N-dibutylaminocarbonyl, N,N-di(1-methylpropyl)aminocarbonyl, N,N-di(2-methylpropyl)aminocarbonyl, N,N-di(1,1-dimethylethyl)aminocarbonyl, N-ethyl-N-methylaminocarbonyl, N-methyl-N-propylaminocarbonyl, N-methyl-N-(1-methylethyl)aminocarbonyl, N-butyl-N-methylaminocarbonyl, N-methyl-N-(1-methylpropyl)aminocarbonyl, N-methyl-N-(2-methylpropyl)aminocarbonyl, N-(1,1-dimethylethyl)-N-methylaminocarbonyl, N-ethyl-N-propylaminocarbonyl, N-ethyl-N-(1-methylethyl)aminocarbonyl, N-butyl-N-ethylaminocarbonyl, N-ethyl-N-(1-methylpropyl)aminocarbonyl, N-ethyl-N-(2-methylpropyl)aminocarbonyl, N-ethyl-N-(1,1-dimethylethyl)aminocarbonyl, N-(1-methylethyl)-N-propylaminocarbonyl, N-butyl-N-propylaminocarbonyl, N-(1-methylpropyl)-N-propylaminocarbonyl, N-(2-methylpropyl)-N-propylaminocarbonyl, N-(1,1-dimethylethyl)-N-propylaminocarbonyl, N-butyl-N-(1-methylethyl)aminocarbonyl, N-(1-methylethyl)-N-(1-methylpropyl)aminocarbonyl, N-(1-methylethyl)-N-(2-methylpropyl)aminocarbonyl, N-(1,1-dimethylethyl)-N-(1-methylethyl)aminocarbonyl, N-butyl-N-(1-methylpropyl)aminocarbonyl, N-butyl-N-(2-methylpropyl)aminocarbonyl, N-butyl-N-(1,1-dimethylethyl)aminocarbonyl, N-(1-methylpropyl)-N-(2-methylpropyl)aminocarbonyl, N-(1,1-dimethylethyl)-N-(1-methylpropyl)aminocarbonyl or N-(1,1-dimethylethyl)-N-(2-methylpropyl)aminocarbonyl;
C₁-C₄-alkoxy-C₁-C₄-alkyl: C₁-C₄-alkyl which is substituted by C₁-C₄-alkoxy—as mentioned above —, i.e., for example, CH₂—OCH₃, CH₂—OC₂H₅, n-propoxymethyl, CH₂—OCH(CH₃)₂, n-butoxymethyl, (1-methylpropoxy)methyl, (2-methylpropoxy)methyl, CH₂—OC(CH₃)₃, 2-(methoxy)ethyl, 2-(ethoxy)ethyl, 2-(n-propoxy)ethyl, 2-(1-methylethoxy)ethyl, 2-(n-butoxy)ethyl, 2-(1-methylpropoxy)ethyl, 2-(2-methylpropoxy)ethyl, 2-(1,1-dimethylethoxy)ethyl, 2-(methoxy)propyl, 2-(ethoxy)propyl, 2-(n-propoxy)propyl, 2-(1-methylethoxy)propyl, 2-(n-butoxy)propyl, 2-(1-methylpropoxy)propyl, 2-(2-methylpropoxy)propyl, 2-(1,1-dimethylethoxy)propyl, 3-(methoxy)propyl, 3-(ethoxy)propyl, 3-(n-propoxy)propyl, 3-(1-methylethoxy)propyl, 3-(n-butoxy)propyl, 3-(1-methylpropoxy)propyl, 3-(2-methylpropoxy)propyl, 3-(1,1-dimethylethoxy)propyl, 2-(methoxy)butyl, 2-(ethoxy)butyl, 2-(n-propoxy)butyl, 2-(1-methylethoxy)butyl, 2-(n-butoxy)butyl, 2-(1-methylpropoxy)butyl, 2-(2-methylpropoxy)butyl, 2-(1,1-dimethylethoxy)butyl, 3-(methoxy)butyl, 3-(ethoxy)butyl, 3-(n-propoxy)butyl, 3-(1-methylethoxy)butyl, 3-(n-butoxy)butyl, 3-(1-methylpropoxy)butyl, 3-(2-methylpropoxy)butyl, 3-(1,1-dimethylethoxy)butyl, 4-(methoxy)butyl, 4-(ethoxy)butyl, 4-(n-propoxy)butyl, 4-(1-methylethoxy)butyl, 4-(n-butoxy)butyl, 4-(1-methylpropoxy)butyl, 4-(2-methylpropoxy)butyl or 4-(1,1-dimethylethoxy)butyl, preferably CH₂—OCH₃, CH₂—OC₂H₅, 2-methoxyethyl or 2-ethoxyethyl;
(C₁-C₄-alkyl)carbonyl: CO—CH₃, CO—C₂H₅, CO—CH₂—C₂H₅, CO—CH(CH₃)₂, n-butylcarbonyl, CO—CH(CH₃)—C₂H₅, CO—CH₂—CH(CH₃)₂ or CO—C(CH₃)₃, preferably CO—CH₃ or CO—C₂H₅;
(C₁-C₄-alkoxy)carbonyl: CO—OCH₃, CO—OC₂H₅, n-propoxycarbonyl, CO—OCH(CH₃)₂, n-butoxycarbonyl, CO—OCH(CH₃)—C₂H₅, CO—OCH₂—CH(CH₃)₂ or CO—OC(CH₃)₃, preferably CO—OCH₃ or CO—OC₂H₅;
C₃-C₆-alkenyl: prop-1-en-1-yl, allyl, 1-methylethenyl, 1-buten-1-yl, 1-buten-2-yl, 1-buten-3-yl, 2-buten-1-yl, 1-methylprop-1-en-1-yl, 2-methylprop-1-en-1-yl, 1-methylprop-2-en-1-yl, 2-methylprop-2-en-1-yl, n-penten-1-yl, n-penten-2-yl, n-penten-3-yl, n-penten-4-yl, 1-methylbut-1-en-1-yl, 2-methylbut-1-en-1-yl, 3-methylbut-1-en-1-yl, 1-methylbut-2-en-1-yl, 2-methylbut-2-en-1-yl, 3-methylbut-2-en-1-yl, 1-methylbut-3-en-1-yl, 2-methylbut-3-en-1-yl, 3-methylbut-3-en-1-yl, 1,1-dimethylprop-2-en-1-yl, 1,2-dimethylprop-1-en-1-yl, 1,2-dimethylprop-2-en-1-yl, 1-ethylprop-1-en-2-yl, 1-ethylprop-2-en-1-yl, n-hex-1-en-1-yl, n-hex-2-en-1-yl, n-hex-3-en-1-yl, n-hex-4-en-1-yl, n-hex-5-en-1-yl, 1-methylpent-1-en-1-yl, 2-methylpent-1-en-1-yl, 3-methylpent-1-en-1-yl, 4-methylpent-1-en-1-yl, 1-methylpent-2-en-1-yl, 2-methylpent-2-en-1-yl, 3-methylpent-2-en-1-yl, 4-methylpent-2-en-1-yl, 1-methylpent-3-en-1-yl, 2-methylpent-3-en-1-yl, 3-methylpent-3-en-1-yl, 4-methylpent-3-en-1-yl, 1-methylpent-4-en-1-yl, 2-methylpent-4-en-1-yl, 3-methylpent-4-en-1-yl, 4-methylpent-4-en-1-yl, 1,1-dimethylbut-2-en-1-yl, 1,1-dimethylbut-3-en-1-yl, 1,2-dimethylbut-1-en-1-yl, 1,2-dimethylbut-2-en-1-yl, 1,2-dimethylbut-3-en-1-yl, 1,3-dimethylbut-1-en-1-yl, 1,3-dimethylbut-2-en-1-yl, 1,3-dimethylbut-3-en-1-yl, 2,2-dimethylbut-3-en-1-yl, 2,3-dimethylbut-1-en-1-yl, 2,3-di ethylbut-2-en-1-yl, 2,3-dimethylbut-3-en-1-yl, 3,3-dimethylbut-1-en-1-yl, 3,3-dimethylbut-2-en-1-yl, 1-ethylbut-1-en-1-yl, 1-ethylbut-2-en-1-yl, 1-ethylbut-3-en-1-yl, 2-ethylbut-1-en-1-yl, 2-ethylbut-2-en-1-yl, 2-ethylbut-3-en-1-yl, 1,1,2-trimethylprop-2-en-1-yl, 1-ethyl-1-methylprop-2-en-1-yl, 1-ethyl-2-methylprop-1-en-1-yl or 1-ethyl-2-methylprop-2-en-1-yl;
C₃-C₆-haloalkenyl: C₃-C₆-alkenyl as mentioned above which is partially or fully substituted by fluorine, chlorine, bromine and/or iodine, i.e., for example, 2-chloroallyl, 3-chloroallyl, 2,3-dichloroallyl, 3,3-dichloroallyl, 2,3,3-trichloroallyl, 2,3-dichlorobut-2-enyl, 2-bromoallyl, 3-bromoallyl, 2,3-dibromoallyl, 3,3-dibromoallyl, 2,3,3-tribromoallyl or 2,3-dibromobut-2-enyl;
cyano-C₃-C₆-alkenyl: for example 2-cyanoallyl, 3-cyanoallyl, 4-cyanobut-2-enyl, 4-cyanobut-3-enyl or 5-cyanopent-4-enyl;
C₃-C₄-alkenyloxy: allyloxy, but-1-en-3-yloxy, but-1-en-4-yloxy, but-2-en-1-yloxy, 1-methylprop-2-enyloxy or 2-methylprop-2-enyloxy;
C₃-C₄-alkenylthio: allylthio, but-1-en-3-ylthio, but-1-en-4-ylthio, but-2-en-1-ylthio, 1-methylprop-2-enylthio or 2-methylprop-2-enylthio;
C₃-C₄-alkenylsulfinyl: for example allylsulfinyl, but-1-en-3-ylsulfinyl, but-1-en-4-ylsulfinyl, but-2-en-1-ylsulfinyl, 1-methylprop-2-enylsulfinyl or 2-methylprop-2-enylsulfinyl;
C₃-C₄-alkenylsulfonyl: allylsulfonyl, but-1-en-3-ylsulfonyl, but-1-en-4-ylsulfonyl, but-2-en-1-ylsulfonyl, 1-methylprop-2-enylsulfonyl or 2-methylprop-2-enylsulfonyl;
C₃-C₆-alkynyl: prop-1-yn-1-yl, prop-2-yn-1-yl, n-but-1-yn-1-yl, n-but-1-yn-3-yl, n-but-1-yn-4-yl, n-but-2-yn-1-yl, n-pent-1-yn-1-yl, n-pent-1-yn-3-yl, n-pent-1-yn-4-yl, n-pent-1-yn-5-yl, n-pent-2-yn-1-yl, n-pent-2-yn-4-yl, n-pent-2-yn-5-yl, 3-methylbut-1-yn-3-yl, 3-methylbut-1-yn-4-yl, n-hex-1-yn-1-yl, n-hex-1-yn-3-yl, n-hex-1-yn-4-yl, n-hex-1-yn-5-yl, n-hex-1-yn-6-yl, n-hex-2-yn-1-yl, n-hex-2-yn-4-yl, n-hex-2-yn-5-yl, n-hex-2-yn-6-yl, n-hex-3-yn-1-yl, n-hex-3-yn-2-yl, 3-methylpent-1-yn-1-yl, 3-methylpent-1-yn-3-yl, 3-methylpent-1-yn-4-yl, 3-methylpent-1-yn-5-yl, 4-methylpent-1-yn-1-yl, 4-methylpent-2-yn-4-yl or 4-methylpent-2-yn-5-yl, preferably prop-2-yn-1-yl;
C₃-C₆-haloalkynyl: C₃-C₆-alkynyl as mentioned above which is partially or fully substituted by fluorine, chlorine, bromine and/or iodine, i.e., for example, 1,1-difluoroprop-2-yn-1-yl, 4-fluorobut-2-yn-1-yl, 4-chlorobut-2-yn-1-yl, 1,1-difluorobut-2-yn-1-yl, 5-fluoropent-3-yn-1-yl or 6-fluorohex-4-yn-1-yl;
cyano-C₃-C₆-alkynyl: for example 3-cyanopropargyl, 4-cyanobut-2-yn-1-yl, 5-cyanopent-3-yn-1-yl and 6-cyanohex-4-yn-1-yl;
(C₁-C₄-haloalkyl)carbonyl: a (C₁-C₄-alkyl)carbonyl radical—as mentioned above—which is partially or fully substituted by fluorine, chlorine, bromine and/or iodine, i.e., for example, CO—CH₂F, CO—CHF₂, CO—CF₃, CO—CH₂Cl, CO—CH(Cl)₂, CO—C(Cl)₃, chlorofluoromethylcarbonyl, dichlorofluoromethylcarbonyl, chlorodifluoromethylcarbonyl, 2-fluoroethylcarbonyl, 2-chloroethylcarbonyl, 2-bromoethylcarbonyl, 2-iodoethylcarbonyl, 2,2-difluoroethylcarbonyl, 2,2,2-trifluoroethylcarbonyl, 2-chloro-2-fluoroethylcarbonyl, 2-chloro-2,2-difluoroethylcarbonyl, 2,2-dichloro-2-fluoroethylcarbonyl, 2,2,2-trichloroethylcarbonyl, CO—C₂F₅, 2-fluoropropylcarbonyl, 3-fluoropropylcarbonyl, 2,2-difluoropropylcarbonyl, 2,3-difluoropropylcarbonyl, 2-chloropropylcarbonyl, 3-chloropropylcarbonyl, 2,3-dichloropropylcarbonyl, 2-bromopropylcarbonyl, 3-bromopropylcarbonyl, 3,3,3-trifluoropropylcarbonyl, 3,3,3-trichloropropylcarbonyl, CO—CH₂—C₂F₅, CO—CF₂—C₂F₅, 1-(CH₂F)-2-fluoroethylcarbonyl, 1-(CH₂Cl)-2-chloroethylcarbonyl, 1-(CH₂Br)-2-bromoethylcarbonyl, 4-fluorobutylcarbonyl, 4-chlorobutylcarbonyl, 4-bromobutylcarbonyl or nonafluorobutylcarbonyl, preferably CO—CF₃, CO—CH₂Cl or 2,2,2-trifluoroethylcarbonyl;
(C₁-C₄-alkyl)carbonyloxy: O—CO—CH₃, O—CO—C₂H₅, O—CO—CH₂—C₂H₅, O—CO—CH(CH₃)₂, O—CO—CH₂—CH₂—C₂H₅, O—CO—CH(CH₃)—C₂H₅, O—CO—CH₂—CH(CH₃)₂ or O—CO—C(CH₃)₃, preferably O—CO—CH₃ or O—CO—C₂H₅;
(C₁-C₄-haloalkyl)carbonyloxy: a (C₁-C₄-alkyl)carbonyloxy radical—as mentioned above—which is partially or fully substituted by fluorine, chlorine, bromine and/or iodine, i.e., for example, O—CO—CH₂F, O—CO—CHF₂, O—CO—CF₃, O—CO—CH₂Cl, O—CO—CH(Cl)₂, O—CO—C(Cl)₃, chlorofluoromethylcarbonyloxy, dichlorofluoromethylcarbonyloxy, chlorodifluoromethylcarbonyloxy, 2-fluoroethylcarbonyloxy, 2-chloroethylcarbonyloxy, 2-bromoethylcarbonyloxy, 2-iodoethylcarbonyloxy, 2,2-difluoroethylcarbonyloxy, 2,2,2-trifluoroethylcarbonyloxy, 2-chloro-2-fluoroethylcarbonyloxy, 2-chloro-2,2-difluoroethylcarbonyloxy, 2,2-dichloro-2-fluoroethylcarbonyloxy, 2,2,2-trichloroethylcarbonyloxy, O—CO—C₂F₅, 2-fluoropropylcarbonyloxy, 3-fluoropropylcarbonyloxy, 2,2-difluoropropylcarbonyloxy, 2,3-difluoropropylcarbonyloxy, 2-chloropropylcarbonyloxy, 3-chloropropylcarbonyloxy, 2,3-dichloropropylcarbonyloxy, 2-bromopropylcarbonyloxy, 3-bromopropylcarbonyloxy, 3,3,3-trifluoropropylcarbonyloxy, 3,3,3-trichloropropylcarbonyloxy, O—CO—CH₂—C₂F₅, O—CO—CF₂—C₂F₅, 1-(CH₂F)-2-fluoroethylcarbonyloxy, 1-(CH₂Cl)-2-chloroethylcarbonyloxy, 1-(CH₂Br)-2-bromoethylcarbonyloxy, 4-fluorobutylcarbonyloxy, 4-chlorobutylcarbonyloxy, 4-bromobutylcarbonyloxy or nonafluorobutylcarbonyloxy;
C₃-C₄-alkynyloxy: propargyloxy, but-1-yn-3-yloxy, but-1-yn-4-yloxy, but-2-yn-1-yloxy, 1-methylprop-2-ynyloxy or 2-methylprop-2-ynyloxy, preferably propargyloxy;
C₃-C₄-alkynylthio: propargylthio, but-1-yn-3-ylthio, but-1-yn-4-ylthio, but-2-yn-1-ylthio, 1-methylprop-2-ynylthio or 2-methylprop-2-ynylthio, preferably propargylthio;
C₃-C₄-alkynylsulfinyl: propargylsulfinyl, but-1-yn-3-ylsulfinyl, but-1-yn-4-ylsulfinyl, but-2-yn-1-ylsulfinyl, 1-methylprop-2-ynylsulfinyl or 2-methylprop-2-ynylsulfinyl, preferably propargylsulfinyl;
C₃-C₄-alkynylsulfonyl: propargylsulfonyl, but-1-yn-3-ylsulfonyl, but-1-yn-4-ylsulfonyl, but-2-yn-1-ylsulfonyl, 1-methylprop-2-ynylsulfonyl or 2-methylprop-2-ynylsulfonyl;
C₃-C₈-cycloalkyl: cyclopropyl, cyclobutyl, cyclopentyl, cyclohexyl, cycloheptyl or cyclooctyl;
C₃-C₈-cycloalkyl-C₁-C₄-alkyl: cyclopropylmethyl, cyclobutylmethyl, cyclopentylmethyl, cyclohexylmethyl, cycloheptylmethyl, cyclooctylmethyl, 2-(cyclopropyl)ethyl, 2-(cyclobutyl)ethyl, 2-(cyclopentyl)ethyl, 2-(cyclohexyl)ethyl, 2-(cycloheptyl)ethyl, 2-(cyclooctyl)ethyl, 3-(cyclopropyl)propyl, 3-(cyclobutyl)propyl, 3-(cyclopentyl)propyl, 3-(cyclohexyl)propyl, 3-(cycloheptyl)propyl, 3-(cyclooctyl)propyl, 4-(cyclopropyl)butyl, 4-(cyclobutyl)butyl, 4-(cyclopentyl)butyl, 4-(cyclohexyl)butyl, 4-(cycloheptyl)butyl, 4-(cyclooctyl)butyl;
C₃-C₈-cycloalkyloxy: cyclopropyloxy, cyclobutyloxy, cyclopentyloxy, cyclohexyloxy, cycloheptyloxy, cyclooctyloxy;

C₃-C₈-cycloalkenyl: cyclopropenyl, cyclobutenyl, cyclopentenyl, cyclohexenyl, cycloheptenyl or cyclooctenyl.

Preferred herbicides B which can be used according to the present invention in combination with the 7-pyrazolylbenzoxazoles of the formula I are:
b1) from the group of the lipid biosynthesis inhibitors:
   chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate and bensulide;
b2) from the group of the ALS inhibitors: amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;
b3) from the group of the photosynthesis inhibitors: atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine, terbutryne, trietazine, ametridione, amibuzin, hexazinone, isomethiozin, metamitron, metribuzin, bromacil, isocil, lenacil, terbacil, brompyrazon, chloridazon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluron, anisuron, buturon, chlorbromuron, chloreturon, chlorotoluron, chloroxuron, difenoxuron, dimefuron, diuron, fenuron, fluometuron, fluothiuron, isoproturon, linuron, methiuron, metobenzuron, metobromuron, metoxuron, monolinuron, monuron, neburon, parafluron, phenobenzuron, siduron, tetrafluron, thidiazuron, cyperquat, diethamquat, difenzoquat, diquat, morfamquat, paraquat, bromobonil, bromoxynil, chloroxynil, iodobonil, ioxynil, amicarbazone, bromofenoxim, flumezin, methazole, bentazone, propanil, pentanochlor, pyridate, and pyridafol;
b4) from the group of the protoporphyrinogen-IX oxidase inhibitors: acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen, etnipromid and phenyluracil compounds of the formula II: 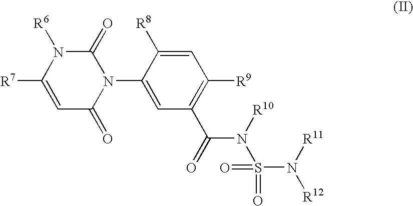
in which the variables R⁶-R¹² are as defined below:
   R⁶ is methyl or NH₂;
   R⁷ is C₁-C₂-haloalkyl;
   R⁸ is hydrogen or halogen;
   R⁹ is halogen or cyano;
   R¹⁰ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or alkyl;
   R¹¹, R¹² independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl, where each of the 8 last-mentioned substituents is unsubstituted or may be substituted by 1 to 6 halogen atoms and/or by one, two or three groups selected from: OH, NH₂, CN, CONH₂, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, C₁-C₄-alkylamino, di-(C₁-C₄-alkyl)amino, formyl, C₁-C₄-alkylcarbonyl, C₁-C₄-alkoxycarbonyl, C₁-C₄-alkylaminocarbonyl, di(C₁-C₄-alkyl)aminocarbonyl, C₃-C₇-cycloalkyl, phenyl or benzyl; or
   R¹¹, R¹² together with the nitrogen atom form a 3-, 4-, 5-, 6- or 7-membered saturated or unsaturated nitrogen heterocycle which is unsubstituted or substituted by 1 to 6 methyl groups and which may contain, as ring members, 1 or 2 further heteroatoms selected from the group consisting of nitrogen, oxygen and sulfur,
b5) from the group of the bleacher herbicides: metflurazon, norflurazon, flufenican, diflufenican, picolinafen, beflubutamid, fluridone, flurochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethylphenoxy)-2-(4-trifluoromethylphenyl)pyrimidine and also 3-heterocyclyl-substituted benzoyl derivatives of the formula III 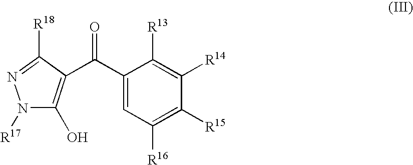
in which the variables R¹³ to R¹⁸ are as defined below:
   R¹³, R¹⁵ are hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl;
   R¹⁴ is a heterocyclic radical selected from the group consisting of: thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, where the nine radicals mentioned may be unsubstituted or mono- or polysubstituted by halogen, C₁-C₄-alkyl, C₁-C₄-alkoxy, C₁-C₄-haloalkyl, C₁-C₄-haloalkoxy or C₁-C₄-alkylthio;
   R¹⁶ is hydrogen, halogen or C₁-C₆-alkyl;
   R¹⁷ is C₁-C₆-alkyl;
   R¹⁸ is hydrogen or C₁-C₆-alkyl;
b6) from the group of the EPSP synthase inhibitors: glyphosate;
b7) from the group of the glutamine synthase inhibitors: glufosinate and bilanaphos;
b8) from the group of the DHP synthase inhibitors: asulam;
b9) from the group of the mitose inhibitors: benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, chlorthal, carbetamide, chlorbufam, chlorpropham and propham;
b10) from the group of the VLCFA inhibitors: acetochlor, alachlor, butachlor, butenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane;
b11) from the group of the cellulose biosynthesis inhibitors: dichlobenil, chlorthiamid, isoxaben and flupoxam;
b12) from the group of the decoupler herbicides: dinofenate, dinoprop, dinosam, dinoseb, dinoterb, DNOC, etinofen and medinoterb;
b13) from the group of the auxin herbicides:

clomeprop, 2,4-D, 2,4,5-T, MCPA, MCPA-thioethyl, dichlorprop, dichlorprop-P, mecoprop, mecoprop-P, 2,4-DB, MCPB, chloramben, dicamba, 2,3,6-TBA, tricamba, quinclorac, quinmerac, clopyralid, fluroxypyr, picloram, triclopyr and benazolin;
b14) from the group of the auxin transport inhibitors: naptalam, diflufenzopyr;
b15) from the group of other herbicides: benzoylprop, flamprop, flamprop-M, bromobutide, chlorflurenol, cinmethylin, methyldymron, etobenzanid, fosamine, metam, pyributicarb, oxaziclomefone, dazomet, triaziflam, methyl bromide, daimuron (dymron) and cumyluron.

The 7-pyrazolylbenzoxazoles of the formula I are included in the general formula of the compounds disclosed in WO 98/27090 and WO 99/55702. The 7-pyrazolylbenzoxazoles of the formula I can be prepared by the processes described in these publications and by the processes described in WO 01/68644 and in the earlier application DE 101 01 762.6, which are expressly included herein by way of reference.

The active compounds B of groups b1) to b15) and the active compounds C are known herbicides and safeners, see, for example, The Compendium of Pesticide Common Names (http://www.hclrss.demon.co.uk/index.html); Farm Chemicals Handbook 2000 Vol. 86, Meister Publishing Company, 2000; B. Hock, C. Fedtke, R. R. Schmidt, Herbizide, Georg Thieme Verlag, Stuttgart 1995; W. H. Ahrens, Herbicide Handbook, 7^{th} Edition, Weed Science Society of America, 1994; and K. K. Hatzios, Herbicide Handbook, Supplement to ₇th Edition, Weed Science Society of America, 1998. 2,2,5-Trimethyl-3-(dichloroacetyl)-1,3-oxazolidine [CAS No. 52836-31-4] is also known as R-29148. 4-(Dichloroacetyl)-1-oxa-4-azaspiro[4.5]decane [CAS No. 71526-07-3] is also known as AD-67 and MON 4660. 4-(3-Trifluoromethylphenoxy)-2-(4-trifluoromethylphenyl)pyrimidine is known from EP 723960. The bleacher herbicides of the formula III described below are disclosed in WO 96/26202, WO 97/41116, WO 97/41117 and WO 97/41118. The protoporphyrinogen-IX oxidase inhibitors of the formula II described below are known from the earlier patent application WO 01/83459.

The categorization of the active compounds according to their mode of action is based on current understanding. If an active compound acts by more than one mode of action, this substance was assigned to only one mode of action.

If the 7-pyrazolylbenzoxazoles I, the herbicides B and/or the safeners C are capable of forming geometrical isomers, for example E/Z isomers, it is possible to use both the pure isomers and mixtures thereof in the compositions according to the invention. If the 7-pyrazolylbenzoxazoles I, the herbicides B and/or the safeners C have one or more centers of chirality and, as a consequence, are present as enantiomers or diastereomers, it is possible to use both the pure enantiomers and diastereomers and their mixtures in the compositions according to the invention.

If the 7-pyrazolylbenzoxazoles I, the herbicides B and/or the safeners C have functional groups which can be ionized, they can also be used in the form of their agriculturally acceptable salts. In general, the salts of those cations or the acid addition salts of those acids are suitable whose cations and anions, respectively, have no adverse effect on the action of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)eth-1-ylammonium, di(2-hydroxyethyl)]ammonium, benzyltrimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium.

It is possible to use, for example, the active compounds of the formula I which have an acid group, the active compounds II and III and chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, propaquizafop, quizalofop, quizalofop-P, trifop, alloxydim, butroxydim, clethodim, cloproxydim, cycloxydim, profoxydim, sethoxydim, tepraloxydim, tralkoxydim, amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, propoxycarbazon, flucarbazon, imazamethabenz, imazamox, imazapic, imazapyr, imazaquin, imazethapyr, cloransulam, diclosulam, florasulam, flumetsulam, metosulam, penoxsulam, bispyribac, pyrithiobac, pyriminobac, bentazon, acifluorfen, ethoxyfen, fluoroglycofen, fomesafen, halosafen, lactofen, pyraflufen, flumiclorac, fluthiacet, carfentrazone, flufenpyr, mesotrione, sulcotrione, glyphosate, glufosinate, bilanaphos, clomeprop, 2,4-D, 2,4-DB, dichlorprop, dichlorprop-P, MCPA, MCPB, mecoprop, mecoprop-P, 2,4,5-T, chloramben, dicamba, 2,3,6-TBA, tricamba, quinclorac, quinmerac, clopyralid, fluroxypyr, picloram, triclopyr, naptalam, diflufenzopyr, cloquintocet, fenchlorazole, isoxadifen and mefenpyr, if desired as salts of the agriculturally useful cations mentioned above, in the compositions according to the invention.

Anions of useful acid addition salts are primarily chloride, bromide, fluoride, iodide, hydrogen sulfate, methyl sulfate, sulfate, dihydrogen phosphate, hydrogen phosphate, nitrate, dicarbonate, carbonate, hexafluorosilicate, hexafluorophosphate, benzoate and the anions of C₁-C₄-alkanoic acids, preferably formate, acetate, propionate and butyrate.

In the compositions according to the invention, the active compounds cyperquat, diethamquat, difenzoquat, diquat, morfamquat and paraquat are usually employed as salts of the agriculturally useful anions mentioned above.

The active compounds I can be used in the mixtures according to the invention as acid addition salts, as mentioned above.

In the compositions according to the invention, the active compounds which carry a carboxyl group can, instead of the active compounds mentioned above, also be employed in the form of an agriculturally acceptable derivative, for example as amides such as mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters. Examples of active compounds having a COOH group which can also be employed as derivatives are: chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, propaquizafop, quizalofop, quizalofop-P, trifop, bensulfuron, chlorimuron, ethametsulfuron, flupyrsulfuron, halosulfuron, iodosulfuron, mesosulfuron, metsulfuron, primisulfuron, pyrazosulfuron, sulfometuron, thifensulfuron, tribenuron, triflusulfuron, imazamethabenz, imazamox, imazapic, imazapyr, imazaquin, imazethapyr, cloransulam, bispyribac, pyrithiobac, pyriminobac, acifluorfen, ethoxyfen, fluoroglycofen, lactofen, pyraflufen, flumiclorac, fluthiacet, carfentrazone, flufenpyr, clomeprop, 2,4-D, 2,4-DB, dichlorprop, dichlorprop-P, MCPA, MCPB, mecoprop, mecoprop-P, 2,4,5-T, chloramben, dicamba, 2,3,6-TBA, tricamba, quinclorac, quinmerac, clopyralid, fluroxypyr, picloram, triclopyr, naptalam, diflufenzopyr, cloquintocet, fenchlorazole, isoxadifen and mefenpyr.

Preferred mono- and di-C₁-C₆-alkylamides are the methyl- and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxyethyl esters, for example the methoxyethyl, ethoxyethyl or butoxyethyl esters. An example of the straight-chain or branched C₁-C₁₀-alkyl thioesters is the ethyl thioester.

Among the 7-pyrazolylbenzoxazoles of the formula I, preference is given to those in which the variables R¹ to R⁵ independently of one another, but preferably combined, have the meanings given below:
R¹ is difluoromethoxy;
R² is chlorine or bromine;
R³ is hydrogen, fluorine or chlorine, in particular fluorine or chlorine;
R⁴ is halogen or cyano, preferably chlorine or cyano, with very particular preference chlorine;
R⁵ is hydrogen, C₁-C₆-alkyl, C₁-C₆-haloalkyl, C₁-C₄-alkoxy-C₁-C₄-alkyl, C₃-C₆-alkenyl, C₃-C₆-alkynyl, C₃-C₇-cycloalkyl, C₃-C₈-cycloalkyl-C₁-C₄-alkyl, phenyl or benzyl, in particular C₁-C₄-alkyl, cyclopropyl or cyclopropylmethyl and with very particular preference C₁-C₄-alkyl.

Examples of particularly preferred herbicides I are the compounds of the formula Ia listed below in which R², R³ and R⁵ together have the values given in one row of Table 1 (compounds I.1 to I.76)

| | |
|---|---|
| | (Ia) |
| 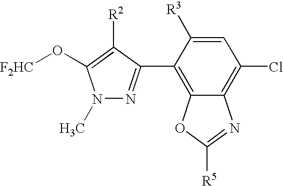 | |

| 7-pyrazolylbenzoxazole I | R² | R³ | R⁵ |
|---|---|---|---|
| I.1 | Cl | F | H |
| I.2 | Cl | Cl | H |
| I.3 | Br | F | H |
| I.4 | Br | Cl | H |
| I.5 | Cl | F | methyl |
| I.6 | Cl | Cl | methyl |
| I.7 | Br | F | methyl |
| I.8 | Br | Cl | methyl |
| I.9 | Cl | F | ethyl |
| I.10 | Cl | Cl | ethyl |
| I.11 | Br | F | ethyl |
| I.12 | Br | Cl | ethyl |
| I.13 | Cl | F | propyl |
| I.14 | Cl | Cl | propyl |
| I.15 | Br | F | propyl |
| I.16 | Br | Cl | propyl |
| I.17 | Cl | F | isopropyl |
| I.18 | Cl | Cl | isopropyl |
| I.19 | Br | F | isopropyl |
| I.20 | Br | Cl | isopropyl |
| I.21 | Cl | F | butyl |
| I.22 | Cl | Cl | butyl |
| I.23 | Br | F | butyl |
| I.24 | Br | Cl | butyl |
| I.25 | Cl | F | s-butyl |
| I.26 | Cl | Cl | s-butyl |
| I.27 | Br | F | s-butyl |
| I.28 | Br | Cl | s-butyl |
| I.29 | Cl | F | isobutyl |
| I.30 | Cl | Cl | isobutyl |
| I.31 | Br | F | isobutyl |
| I.32 | Br | Cl | isobutyl |
| I.33 | Cl | F | t-butyl |
| I.34 | Cl | Cl | t-butyl |
| I.35 | Br | F | t-butyl |
| I.36 | Br | Cl | t-butyl |
| I.37 | Cl | F | trifluoromethyl |
| I.38 | Cl | Cl | trifluoromethyl |
| I.39 | Br | F | trifluoromethyl |
| I.40 | Br | Cl | trifluoromethyl |
| I.41 | Cl | F | methoxymethyl |
| I.42 | Cl | Cl | methoxymethyl |
| I.43 | Br | F | methoxymethyl |
| I.44 | Br | Cl | methoxymethyl |
| I.45 | Cl | F | cyclopropyl |
| I.46 | Cl | Cl | cyclopropyl |
| I.47 | Br | F | cyclopropyl |
| I.48 | Br | Cl | cyclopropyl |
| I.49 | Cl | F | cyclopentyl |
| I.50 | Cl | Cl | cyclopentyl |
| I.51 | Br | F | cyclopentyl |
| I.52 | Br | Cl | cyclopentyl |
| I.53 | Cl | F | cyclohexyl |
| I.54 | Cl | Cl | cyclohexyl |
| I.55 | Br | F | cyclohexyl |
| I.56 | Br | Cl | cyclohexyl |
| I.57 | Cl | F | (cyclopropyl)methyl |
| I.58 | Cl | Cl | (cyclopropyl)methyl |
| I.59 | Br | F | (cyclopropyl)methyl |
| I.60 | Br | Cl | (cyclopropyl)methyl |
| I.61 | Cl | F | (cyclopentyl)methyl |
| I.62 | Cl | Cl | (cyclopentyl)methyl |
| I.63 | Br | F | (cyclopentyl)methyl |
| I.64 | Br | Cl | (cyclopentyl)methyl |
| I.65 | Cl | F | (cyclohexyl)methyl |
| I.66 | Cl | Cl | (cyclohexyl)methyl |
| I.67 | Br | F | (cyclohexyl)methyl |
| I.68 | Br | Cl | (cyclohexyl)methyl |
| I.69 | Cl | F | phenyl |
| I.70 | Cl | Cl | phenyl |
| I.71 | Br | F | phenyl |
| I.72 | Br | Cl | phenyl |
| I.73 | Cl | F | benzyl |
| I.74 | Cl | Cl | benzyl |
| I.75 | Br | F | benzyl |
| I.76 | Br | Cl | benzyl |

Among the compositions according to the invention, preference is given to those which comprise at least one herbicide B selected from groups b1) to b7), b9) to b11), b13) to b15).

Among the compositions according to the invention, particular preference is given to those which comprise at least one herbicide B selected from groups b1), b2), b5), b6), b7), b9), b10), b13), b14) and b15), in particular selected from groups b1), b2), b5), b6), b7), b9) and b15).

Preferred herbicides B of groups b1) to b15) are the compounds listed below:
b1) clodinafop, cyhalofop, diclofop, fenoxaprop, fenoxaprop-P, fluazifop, fluazifop-P, haloxyfop, haloxyfop-P, metamifop, quizalofop, quizalofop-P, alloxydim, butroxydim, clethodim, cloproxydim, cycloxydim, profoxydim, sethoxydim, tepraloxydim, tralkoxydim;
b2) amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, propoxycarbazone, flucarbazone, imazamethabenz, imazamox, imazapic, imazapyr, imazaquin, imazethapyr, cloransulam, diclosulam, florasulam, flumetsulam, metosulam, penoxsulam, bispyribac, pyribenzoxim, pyriftalid, pyrithiobac, pyriminobac;
b3) atrazine, cyanazine, simazine, terbuthylazine, hexazinone, metamitron, metribuzin, amicarbazone, chloridazon, chlorbromuron, chlorotoluron, diuron, isoproturon, linuron, methabenzthiazuron, propanil, bromoxynil, ioxynil, bentazone, pyridate, difenzoquat, diquat, paraquat;
b4) acifluorfen, fluoroglycofen, halosafen, lactofen, oxyfluorfen, fluazolate, pyraflufen, cinidon-ethyl, flumiclorac, flumioxazin, fluthiacet, oxadiazon, oxadiargyl, azafenidin, carfentrazone, sulfentrazone, pentoxazone, benzfendizone, butafenacil, pyraclonil, profluazol, flufenpyr, nipyraclofen, 2-chloro-5-[3,6-dihydro-3-methyl-2,6-dioxo-4-(trifluoromethyl)-1(2H)-pyrimidinyl]-N-(dimethylsulfamoyl)-4-fluorobenzamide, 5-[3-amino-3,6-dihydro-2,6-dioxo-4-(trifluoromethyl)-1(2H)-pyrimidinyl]-2-chloro-N-(dimethylsulfamoyl)-4-fluorobenzamide, 2-chloro-5-[3,6-dihydro-3-methyl-2,6-dioxo-4-(trifluoromethyl)-1(2H)-pyrimidinyl]-N-[(ethyl)methylsulfamoyl]-4-fluorobenzamide, 5-[3-amino-3,6-dihydro-2,6-dioxo-4-(trifluoromethyl)-1(2H)-pyrimidinyl]-2-chloro-N-[(ethyl)methylsulfamoyl]-4-fluorobenzamide, 2-chloro-5-[3,6-dihydro-3-methyl-2,6-dioxo-4-(trifluoromethyl)-1(2H)-pyrimidinyl]-4-fluoro-N-[(methyl)propylsulfamoyl]benzamide, 5-[3-amino-3,6-dihydro-2,6-dioxo-4-(trifluoromethyl)-1(2H)-pyrimidinyl]-2-chloro-4-fluoro-N-[(methyl)propylsulfamoyl]benzamide, 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]benzamide, 5-[3-amino-3,6-dihydro-2,6-dioxo-4-(trifluoromethyl)-1(2H)-pyrimidinyl]-2-chloro-4-fluoro-N-[(isopropyl)methylsulfamoyl]benzamide, N-[(butyl)methylsulfamoyl]-2-chloro-5-[3,6-dihydro-3-methyl-2,6-dioxo-4-(trifluoromethyl)-1(2H)-pyrimidinyl]-4-fluorobenzamide, 5-[3-amino-3,6-dihydro-2,6-dioxo-4-(trifluoromethyl)-1(2H)-pyrimidinyl]-N-[(butyl)methylsulfamoyl]-2-chloro-4-fluorobenzamide, 2-chloro-5-[3,6-dihydro-3-methyl-2,6-dioxo-4-(trifluoromethyl)-1(2H)-pyrimidinyl]-4-fluoro-N-[(isobutyl)methylsulfamoyl]benzamide, 5-[3-amino-3,6-dihydro-2,6-dioxo-4-(trifluoromethyl)-1(2H)-pyrimidinyl]-2-chloro-4-fluoro-N-[(isobutyl)methylsulfamoyl]benzamide, 2-chloro-5-[3,6-dihydro-3-methyl-2,6-dioxo-4-(trifluoromethyl)-1(2H)-pyrimidinyl]-N-(dimethylsulfamoyl)benzamide, 5-[3-amino-3,6-dihydro-2,6-dioxo-4-(trifluoromethyl)-1(2H)-pyrimidinyl]-2-chloro-N-(dimethylsulfamoyl)benzamide, 2-chloro-5-[3,6-dihydro-3-methyl-2,6-dioxo-4-(trifluoromethyl)-1(2H)-pyrimidinyl]-N-[(ethyl)methylsulfamoyl]benzamide, 5-[3-amino-3,6-dihydro-2,6-dioxo-4-(trifluoromethyl)-1(2H)-pyrimidinyl]-2-chloro-N-[(ethyl)methylsulfamoyl]benzamide, 2-chloro-5-[3,6-dihydro-3-methyl-2,6-dioxo-4-(trifluoromethyl)-1(2H)-pyrimidinyl]-N-[(methyl)propylsulfamoyl]benzamide, 5-[3-amino-3,6-dihydro-2,6-dioxo-4-(trifluoromethyl)-1(2H)-pyrimidinyl]-2-chloro-N-[(methyl)propylsulfamoyl]benzamide, 2-chloro-5-[3,6-dihydro-3-methyl-2,6-dioxo-4-(trifluoromethyl)-1(2H)-pyrimidinyl]-N-[(isopropyl)methylsulfamoyl]benzamide, 5-[3-amino-3,6-dihydro-2,6-dioxo-4-(trifluoromethyl)-1(2H)-pyrimidinyl]-2-chloro-N-[(isopropyl)methylsulfamoyl]benzamide, N-[(butyl)methylsulfamoyl]-2-chloro-5-[3,6-dihydro-3-methyl-2,6-dioxo-4-(trifluoromethyl)-1(2H)-pyrimidinyl]benzamide, 5-[3-amino-3,6-dihydro-2,6-dioxo-4-(trifluoromethyl)-1(2H)-pyrimidinyl]-N-[(butyl)methylsulfamoyl]-2-chlorobenzamide, 2-chloro-5-[3,6-dihydro-3-methyl-2,6-dioxo-4-(trifluoromethyl)-1(2H)-pyrimidinyl]-N-[(isobutyl)methylsulfamoyl]benzamide, 5-[3-amino-3,6-dihydro-2,6-dioxo-4-(trifluoromethyl)-1(2H)-pyrimidinyl]-2-chloro-N-[(isobutyl)methylsulfamoyl]benzamide;
b5) norflurazon, diflufenican, picolinafen, beflubutamid, fluridone, flurochloridone, flurtamone, mesotrione, sulcotrione, isoxachlortole, isoxaflutole, benzofenap, pyrazolynate, pyrazoxyfen, benzobicyclon, clomazone, [2-chloro-3-(4,5-dihydro-3-isoxazolyl)-4-(methylsulfonyl)phenyl](5-hydroxy-1-methyl-1H-pyrazol-4-yl)methanone, [3-(4,5-dihydro-3-isoxazolyl)-2-methyl-4-(methylsulfonyl)phenyl](5-hydroxy-1-methyl-1H-pyrazol-4-yl)methanone, [2-chloro-3-(3-methyl-5-isoxazolyl)-4-(methylsulfonyl)phenyl](5-hydroxy-1-methyl-1H-pyrazol-4-yl)methanone, (5-hydroxy-1-methyl-1H-pyrazol-4-yl)[2-methyl-3-(3-methyl-5-isoxazolyl)-4-(methylsulfonyl)phenyl]methanone, and also 4-(3-trifluoromethylphenoxy)-2-(4-trifluoromethylphenyl)pyrimidine;
b6) glyphosate;
b7) glufosinate;
b9) benfluralin, butralin, dinitramine, ethalfluralin, oryzalin, pendimethalin, trifluralin, propyzamide;
b10) acetochlor, alachlor, butachlor, dimethenamid, dimethenamid-P, metazachlor, metolachlor, S-metolachlor, pethoxamid, pretilachlor, propachlor, propisochlor, thenylchlor, flufenacet, mefenacet, fentrazamide, cafenstrole, indanofan;
b11) dichlobenil, chlorthiamid, isoxaben and flupoxam;
b13) 2,4-D, 2,4-DB, dichlorprop, dichlorprop-P, MCPA, MCPB, mecoprop, mecoprop-P, dicamba, quinclorac, quinmerac, clopyralid, fluroxypyr, picloram, triclopyr, benazolin;
b14) diflufenzopyr;
b15) bromobutide, cinmethylin, methyldymron, oxaziclomefone, triaziflam, daimuron (dymron) and cumyluron;
   and also their agriculturally acceptable salts and, in the case of compounds with a carboxyl group, also their agriculturally acceptable derivatives.

In a particularly preferred embodiment of the invention, the compositions according to the invention comprise, as active compound B), a compound selected from the group consisting of tepraloxydim, profoxydim, cyhalofop, sethoxydim, cyclosulfamuron, nicosulfuron, imazapyr, imazaquin, propoxycarbazone, pyrazosulfuron, imazamox, imazethapyr, imazapic, bentazone, atrazine, isoproturon, paraquat, clomazone, mesotrione, picolinafen, glyphosate, glufosinate, pendimethalin, acetochlor, S-metolachlor, flufenacet, dimethenamid-P, isoxaben, 2,4-D, quinclorac, dicamba, bromobutide, methyldymron, oxaziclomefone, daimuron (dymron), cumyluron and diflufenzopyr and also, in the case of ionizable or ionic herbicides such as tepraloxydim, profoxydim, sethoxydim, pyrazosulfuron, cyclosulfamuron, nicosulfuron, imazamox, imazethapyr, imazapic, imazapyr, imazaquin, propoxycarbazone, bentazone, paraquat, mesotrione, glyphosate, glufosinate, 2,4-D, dicamba, quinclorac and diflufenzopyr, their salts, in particular their salts with the cations or anions mentioned as being preferred, and also, in the case of compounds with a carboxyl group such as pyrazosulfuron, imazamox, imazethapyr, imazapic, imazapyr, imazaquin, 2,4-D, dicamba and quinclorac, their derivatives, in particular the esters or amides mentioned as being preferred.

Among the particularly preferred compositions according to the invention which comprise at least one protoporphyrinogen-IX oxidase inhibitor b4), one embodiment of the invention relates to those compositions which, as protoporphyrinogen-IX oxidase inhibitor b4), comprise a compound of the formula II. In this embodiment, preference is given to those compositions which comprise a compound of the formula II in which the variables R⁶ to R¹² independently of one another and particularly preferably together have the following meanings:
R⁶ is methyl or NH₂;
R⁷ is trifluoromethyl;
R⁸ is hydrogen, fluorine or chlorine, in particular fluorine or hydrogen;
R⁹ is halogen or cyano, in particular chlorine or cyano;
R¹⁰ is hydrogen;
R¹¹, R¹² independently of one another are hydrogen, C₁-C₆-alkyl, C₃-C₆-alkenyl, C₃-C₆-alkynyl, C₃-C₇-cycloalkyl, C₃-C₇-cycloalkenyl, phenyl or benzyl, or
R¹¹, R¹² together with the nitrogen atom form a pyrrolidine, piperidine, morpholine, N-methylpiperazine or perhydroazepine ring.

R¹¹, R¹² are in particular C₁-C₆-alkyl, which may be identical or different.

Among the compositions which comprise at least one bleacher herbicide b5) and are particularly preferred according to the invention, one embodiment of the invention relates to those compositions which, as bleacher herbicide b5), comprise a compound of the formula III. In this embodiment, preference is given to those compositions which comprise a compound of the formula III in which the variables R¹³ to R¹⁸ independently of one another and particularly preferably together have the following meanings:
R¹³ is halogen, C₁-C₄-alkyl, C₁-C₄-alkylthio, C₁-C₄-alkylsulfinyl or C₁-C₄-alkylsulfonyl, in particular halogen or C₁-C₄-alkyl and especially methyl or chlorine;
R¹⁴ is a heterocyclic radical selected from the group consisting of: isoxazol-3-yl, isoxazol-5-yl and 4,5-dihydroisoxazol-3-yl, where the three radicals mentioned may be unsubstituted or mono- or disubstituted by halogen, C₁-C₄-alkyl, C₁-C₄-alkoxy or C₁-C₄-haloalkyl, in particular isoxazol-5-yl or 4,5-dihydroisoxazol-3-yl, which may be substituted in the above manner, preferably by one or two C₁-C₄-alkyl, in particular methyl, groups, for example 4,5-dihydroisoxazol-3-yl or 3-methylisoxazol-5-yl;
R¹⁵ is halogen, C₁-C₄-alkyl, C₁-C₄-alkylthio, C₁-C₄-alkylsulfinyl or C₁-C₄-alkylsulfonyl, in particular C₁-C₄-alkylsulfonyl and particularly preferably methylsulfonyl;
R¹⁶ is hydrogen;
R¹⁷ is C₁-C₄-alkyl;
R¹⁸ is hydrogen or C₁-C₄-alkyl, in particular hydrogen.

In another particularly preferred embodiment of the invention, the compositions according to the invention comprise, as active compounds C, at least one of the compounds listed below: benoxacor, cloquintocet, dichlormid, fenchlorazole, fenclorim, fluxofenim, furilazole, isoxadifen, mefenpyr, 2,2,5-trimethyl-3-(dichloroacetyl)-1,3-oxazolidine, 4-(dichloroacetyl)-1-oxa-4-azaspiro[4.5]decane and oxabetrinil and/or an agriculturally acceptable salt thereof and/or, in the case of compounds having a COOH group, an agriculturally acceptable derivative.

In another particularly preferred embodiment of the invention, preference is given to those binary and ternary compositions which comprise at least one 7-pyrazolylbenzoxazole of the formula I as active compound A and at least one herbicide selected from classes b1) to b15) and, if appropriate, one or more safeners C. Very particular preference is given to those binary and ternary compositions which comprise at least one 7-pyrazolylbenzoxazole of the formula I as active compound A and at least one herbicide selected from classes b1), b2), b3), b5), b6), b7), b9), b10), b13), b14) and b15) and, if appropriate, one or more safeners C.

Particularly preferred are those compositions which comprise, as active compound A), a 7-pyrazolylbenzoxazole compound of the formula I in which R¹ is difluoromethoxy, R² is chlorine or bromine, R³ is fluorine or chlorine, R⁴ is Cl and R⁵ is C₁-C₄-alkyl and, as active compound B), a compound selected from the group consisting of tepraloxydim, profoxydim, cyhalofop, sethoxydim, cyclosulfamuron, pyrazosulfuron, imazamox, imazethapyr, imazapic, imazapyr, imazaquin, nicosulfuron, propoxycarbazone, dicamba, bentazone, atrazine, isoproturon, paraquat, clomazone, mesotrione, picolinafen, glyphosate, glufosinate, pendimethalin, acetochlor, S-metolachlor, bromobutide, flufenacet, dimethenamid-P, isoxaben, 2,4-D, quinclorac, methyldymron, oxaziclomefone, daimuron (dymron), cumyluron and diflufenzopyr and also, in the case of ionizable or ionic herbicides such as tepraloxydim, profoxydim, sethoxydim, pyrazosulfuron, cyclosulfamuron, imazamox, imazethapyr, imazapic, imazapyr, imazaquin, nicosulfuron, propoxycarbazone, bentazone, paraquat, mesotrione, glyphosate, glufosinate, 2,4-D, dicamba and difluenzopyr, their salts, in particular with the anions or cations stated as being preferred and also, in the case of compounds having a carboxyl group such as pyrazosulfuron, imazamox, imazethapyr, imazapic, imazapyr, imazaquin, 2,4-D, dicamba and quinclorac, their derivatives, in particular the esters or amides mentioned as being preferred.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b1), in particular selected from the group consisting of clodinafop, cyhalofop, diclofop, fenoxaprop, fenoxaprop-P, profoxydim, sethoxydim, tepraloxydim, tralkoxydim, dimepiperate, esprocarb, molinate and thiobencarb and, if desired, a safener C), in particular selected from the group consisting of fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b2), in particular selected from the group consisting of amidosulfuron, azimsulfuron, bensulfuron, chlorsulfuron, cinosulfuron, cyclosulfamuron, ethoxysulfuron, foramsulfuron, imazosulfuron, iodosulfuron, mesosulfuron, metsulfuron, nicosulfuron, primisulfuron, prosulfuron, pyrazosulfuron, rimsulfuron, sulfosulfuron, trifloxysulfuron, tritosulfuron, propoxycarbazone, flucarbazone, imazamethabenz, imazamox, imazapic, imazapyr, imazaquin, imazethapyr, metosulam, diclosulam, florasulam, penoxsulam, bispyribac, pyribenzoxim, pyriftalid and pyriminobac and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b3), in particular selected from the group consisting of atrazine, cyanazine, terbuthylazine, amicarbazone, chlorotoluron, diuron, isoproturon, methabenzthiazuron, bentazone, propanil, pentanochlor, pyridate, bromoxynil, ioxynil and paraquat and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b5), in particular selected from the group consisting of diflufenican, picolinafen, mesotrione, sulcotrione, isoxaflutole, benzofenap, pyrazolynate, pyrazoxyfen, benzobicyclon, aclonifen, 4-(3-trifluoromethylphenoxy)-2-(4-trifluoromethylphenyl)pyrimidine, [2-chloro-3-(4,5-dihydro-3-isoxazolyl)-4-(methylsulfonyl)phenyl](5-hydroxy-1-methyl-1H-pyrazol-4-yl)methanone and [3-(4,5-dihydro-3-isoxazolyl)-2-methyl-4-(methylsulfonyl)phenyl](5-hydroxy-1-methyl-1H-pyrazol-4-yl)methanone and, if desired, a safener C), in particular selected from the goup consisting of furilazole, fenclorazole, cloquintocet, ioxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b6), in particular glyphosate and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b7), in particular glufosinate and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b9), in particular pendimethalin and dithiopyr and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b10), in particular selected from the group consisting of acetochlor, butachlor, dimethenamid, dimethenamid-P, metolachlor, S-metolachlor, pethoxamid, pretilachlor, thenylchlor, flufenacet, mefenacet, naproanilide, fentrazamide, cafenstrole and indanofan and, if desired, a safener C), in particular selected from the group consisting of 2,2,5-trimethyl-3-(dichloroacetyl)-1,3-oxazolidine, dichlormid, furilazole, oxabetrinil, fluxofenim, benoxacor, fenclorim and 4-(dichloroacetyl)-1-oxa- 4-azaspiro[4.5]decane.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b13), in particular selected from the group consisting of 2,4-D, dichlorprop, dichlorprop-P, mecoprop, MCPA, mecoprop-P, dicamba, quinclorac and quinmerac and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b14), in particular diflufenzopyr and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one herbicidally active compound of the group b15), in particular selected from the group consisting of bromobutide, cinmethylin, methyldymron, pyributicarb, oxaziclomefone, triaziflam, daimuron (dymron) and cumyluron and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one safener C), in particular selected from the group consisting of furilazole, fenclorazole, cloquintocet, isoxadifen and mefenpyr.

In another particularly preferred embodiment of the invention, preference is given to those compositions of the invention which comprise a 7-pyrazolylbenzoxazole of the formula I, especially of formula Ia, in combination with at least one and especially exactly one safener C), in particular selected from the group consisting of 2,2,5-trimethyl-3-(dichloroacetyl)-1,3-oxazolidine, dichlormid, furilazole, oxabetrinil, fluxofenim, benoxacor, fenclorim and 4-(dichloroacetyl)-1-oxa-4-azaspiro[4.5]decane.

In the preferred or especially preferred compositions described above the herbicides B) as well as the safeners C) can be used in the form of their agriculturally acceptable salts or in the form of an agriculturally acceptable derivative thereof as described above. The weight ratios of the individual components in the compositions are within the limits stated above. Among the especially preferred compositions, particular preference is given to those compositions of the invention in which the variables R¹ to R¹⁵ have the preferred meanings, especially the particularly preferred meanings. Particular preference is given to 7-pyrazolylbenzoxazole of the formula Ia as defined above.

Here and below, the term “binary compositions” embraces compositions which comprise one or more, for example 2 or 3, active compounds A and one or more, for example 2 or 3, herbicides B or one or more, for example 2 or 3, safeners C. Correspondingly, the term “ternary compositions” embraces compositions which comprise one or more, for example 2 or 3, active compounds A, one or more, for example 2 or 3, herbicides B and one or more, for example 2 or 3, safeners C.

In binary compositions which comprise at least one 7-pyrazolylbenzoxazole of the formula I as component A and at least one herbicide B, the weight ratio of the active compounds A:B is generally in the range from 1:500 to 10:1, preferably in the range from 1:100 to 10:1, in particular in the range from 1:50 to 10:1 and particularly preferably in the range from 1:25 to 5:1.

In binary compositions which comprise at least one 7-pyrazolylbenzoxazole of the formula I and at least one safener C, the weight ratio of the active compounds A:C is generally in the range from 1:100 to 10:1, preferably from 1:50 to 10:1 and in particular in the range from 1:25 to 5:1.

In ternary compositions comprising both a 7-pyrazolylbenzoxazole I as component A, at least one herbicide B and at least one safener C, the relative weight proportions of the components A:B:C are generally in the range from 10:1:1 to 1:500:10, preferably from 10:1:1 to 1:100:10, in particular from 10:1:1 to 1:50:1 and particularly preferably from 5:1:1 to 1:25:5. In these ternary compositions, the weight ratio of herbicide B to safener C is preferably in the range from 50:1 to 1:10.

Examples of compositions which are preferred according to the invention are those which, as active compound A), comprise the 7-pyrazolylbenzoxazole I.1 and, as further active compound, the substance(s) stated in one row of Table 2 (compositions 1.1 to 1.370). The weight ratios of the individual components in the compositions 1.1 to 1.370 are within the limits stated above, in particular within the preferred limits, in the case of binary mixtures of 7-pyrazolylbenzoxazole I.1 and herbicide B) for example 1:1, 1:2, 1:5, 1:10, 1:20 or 1:50, in the case of binary mixtures of 7-pyrazolylbenzoxazole 1.1 and safener C for example 1:1 or in the case of a ternary mixture of 7-pyrazolylbenzoxazole I.1, herbicide B and safener C for example 1:1:1, 2:1:1, 1:2:1, 1:5:1 or 1:5:2.

TABLE 2

| Composition | | |
|---|---|---|
| No. | Herbicide B) | Safener C) |
| 1.1 | clodinafop | |
| 1.2 | clodinafop | cloquintocet |
| 1.3 | clodinafop | fenchlorazole |
| 1.4 | clodinafop | isoxadifen |
| 1.5 | clodinafop | mefenpyr |
| 1.6 | cyhalofop | |
| 1.7 | cyhalofop | cloquintocet |
| 1.8 | cyhalofop | fenchlorazole |
| 1.9 | cyhalofop | isoxadifen |
| 1.10 | cyhalofop | mefenpyr |
| 1.11 | diclofop | |
| 1.12 | diclofop | cloquintocet |
| 1.13 | diclofop | fenchlorazole |
| 1.14 | diclofop | isoxadifen |
| 1.15 | diclofop | mefenpyr |
| 1.16 | fenoxaprop | |
| 1.17 | fenoxaprop | cloquintocet |
| 1.18 | fenoxaprop | fenchlorazole |
| 1.19 | fenoxaprop | isoxadifen |
| 1.20 | fenoxaprop | mefenpyr |
| 1.21 | fenoxaprop-P | — |
| 1.22 | fenoxaprop-P | cloquintocet |
| 1.23 | fenoxaprop-P | fenchlorazole |
| 1.24 | fenoxaprop-P | isoxadifen |
| 1.25 | fenoxaprop-P | mefenpyr |
| 1.26 | fluazifop | — |
| 1.27 | fluazifop | cloquintocet |
| 1.28 | fluazifop | fenchlorazole |
| 1.29 | fluazifop | isoxadifen |
| 1.30 | fluazifop | mefenpyr |
| 1.31 | fluazifop-P | — |
| 1.32 | fluazifop-P | cloquintocet |
| 1.33 | fluazifop-P | fenchlorazole |
| 1.34 | fluazifop-P | isoxadifen |
| 1.35 | fluazifop-P | mefenpyr |
| 1.36 | haloxyfop | — |
| 1.37 | haloxyfop | cloquintocet |
| 1.38 | haloxyfop | fenchlorazole |
| 1.39 | haloxyfop | isoxadifen |
| 1.40 | haloxyfop | mefenpyr |
| 1.41 | haloxyfop-P | — |
| 1.42 | haloxyfop-P | cloquintocet |
| 1.43 | haloxyfop-P | fenchlorazole |
| 1.44 | haloxyfop-P | isoxadifen |
| 1.45 | haloxyfop-P | mefenpyr |
| 1.46 | quizalofop | — |
| 1.47 | quizalofop | cloquintocet |
| 1.48 | quizalofop | fenchlorazole |
| 1.49 | quizalofop | isoxadifen |
| 1.50 | quizalofop | mefenpyr |
| 1.51 | quizalofop-P | — |
| 1.52 | quizalofop-P | cloquintocet |
| 1.53 | quizalofop-P | fenchlorazole |
| 1.54 | quizalofop-P | isoxadifen |
| 1.55 | quizalofop-P | mefenpyr |
| 1.56 | alloxydim | — |
| 1.57 | butroxydim | — |
| 1.58 | clethodim | — |
| 1.59 | cloproxydim | — |
| 1.60 | cycloxydim | — |
| 1.61 | profoxydim | — |
| 1.62 | sethoxydim | — |
| 1.63 | tepraloxydim | — |
| 1.64 | tralkoxydim | — |
| 1.65 | amidosulfuron | — |
| 1.66 | amidosulfuron | cloquintocet |
| 1.67 | amidosulfuron | fenchlorazole |
| 1.68 | amidosulfuron | isoxadifen |
| 1.69 | amidosulfuron | mefenpyr |
| 1.70 | amidosulfuron | furilazole |
| 1.71 | azimsulfuron | — |
| 1.72 | bensulfuron | — |
| 1.73 | chlorimuron | — |
| 1.74 | chlorsulfuron | — |
| 1.75 | cinosulfuron | — |
| 1.76 | cyclosulfamuron | — |
| 1.77 | ethametsulfuron | — |
| 1.78 | ethoxysulfuron | — |
| 1.79 | flazasulfuron | — |
| 1.80 | flupyrsulfuron | — |
| 1.81 | foramsulfuron | — |
| 1.82 | foramsulfuron | cloquintocet |
| 1.83 | foramsulfuron | fenchlorazole |
| 1.84 | foramsulfuron | isoxadifen |
| 1.85 | foramsulfuron | mefenpyr |
| 1.86 | foramsulfuron | furilazole |
| 1.87 | halosulfuron | — |
| 1.88 | halosulfuron | cloquintocet |
| 1.89 | halosulfuron | fenchlorazole |
| 1.90 | halosulfuron | isoxadifen |
| 1.91 | halosulfuron | mefenpyr |
| 1.92 | halosulfuron | furilazole |
| 1.93 | imazosulfuron | — |
| 1.94 | iodosulfuron | — |
| 1.95 | iodosulfuron | cloquintocet |
| 1.96 | iodosulfuron | fenchlorazole |
| 1.97 | iodosulfuron | isoxadifen |
| 1.98 | iodosulfuron | mefenpyr |
| 1.99 | iodosulfuron | furilazole |
| 1.100 | mesosulfuron | — |
| 1.101 | mesosulfuron | cloquintocet |
| 1.102 | mesosulfuron | fenchlorazole |
| 1.103 | mesosulfuron | isoxadifen |
| 1.104 | mesosulfuron | mefenpyr |
| 1.105 | mesosulfuron | furilazole |
| 1.106 | metsulfuron | — |
| 1.107 | nicosulfuron | — |
| 1.108 | oxasulfuron | — |
| 1.109 | primisulfuron | — |
| 1.110 | prosulfuron | — |
| 1.111 | pyrazosulfuron | — |
| 1.112 | rimsulfuron | — |
| 1.113 | sulfometuron | — |
| 1.114 | sulfosulfuron | — |
| 1.115 | thifensulfuron | — |
| 1.116 | triasulfuron | — |
| 1.117 | tribenuron | — |
| 1.118 | trifloxysulfuron | — |
| 1.119 | triflusulfuron | — |
| 1.120 | tritosulfuron | — |
| 1.121 | propoxycarbazone | — |
| 1.122 | flucarbazone | — |
| 1.123 | imazamethabenz | — |
| 1.124 | imazamox | — |
| 1.125 | imazapic | — |
| 1.126 | imazapyr | — |
| 1.127 | imazaquin | — |
| 1.128 | imazethapyr | — |
| 1.129 | cloransulam | — |
| 1.130 | diclosulam | — |
| 1.131 | florasulam | — |
| 1.132 | flumetsulam | — |
| 1.133 | metosulam | — |
| 1.134 | penoxsulam | — |
| 1.135 | bispyribac | — |
| 1.136 | pyribenzoxim | — |
| 1.137 | pyriftalid | — |
| 1.138 | pyrithiobac | — |
| 1.139 | pyriminobac | — |
| 1.140 | atrazine | — |
| 1.141 | cyanazine | — |
| 1.142 | simazine | — |
| 1.143 | terbuthylazine | — |
| 1.144 | hexazinone | — |
| 1.145 | metamitron | — |
| 1.146 | metribuzin | — |
| 1.147 | amicarbazone | — |
| 1.148 | chloridazone | — |
| 1.149 | chlorbromuron | — |
| 1.150 | chlorotoluron | — |
| 1.151 | diuron | — |
| 1.152 | isoproturon | — |
| 1.153 | linuron | — |
| 1.154 | methabenzthiazuron | — |
| 1.155 | propanil | — |
| 1.156 | bromoxynil | — |
| 1.157 | ioxynil | — |
| 1.158 | bentazone | — |
| 1.159 | pyridate | — |
| 1.160 | difenzoquat | — |
| 1.161 | diquat | — |
| 1.162 | paraquat | — |
| 1.163 | acifluorfen | — |
| 1.164 | fluoroglycofen | — |
| 1.165 | halosafen | — |
| 1.166 | lactofen | — |
| 1.167 | oxyfluorfen | — |
| 1.168 | fluazolate | — |
| 1.169 | pyraflufen | — |
| 1.170 | cinidon-ethyl | — |
| 1.171 | flumiclorac | — |
| 1.172 | flumioxazin | — |
| 1.173 | fluthiacet | — |
| 1.174 | oxadiazone | — |
| 1.175 | oxadiargyl | — |
| 1.176 | azafenidin | — |
| 1.177 | carfentrazone | — |
| 1.178 | sulfentrazone | — |
| 1.179 | pentoxazone | — |
| 1.180 | benzfendizone | — |
| 1.181 | butafenacil | — |
| 1.182 | pyraclonil | — |
| 1.183 | profluazol | — |
| 1.184 | flufenpyr | — |
| 1.185 | nipyraclofen | — |
| 1.186 | 2-chloro-5-[3,6-dihydro-3-methyl- | — |
| | 2,6-dioxo-4-(trifluoromethyl)- | |
| | 1(2H)-pyrimidinyl]-N- | |
| | (dimethylsulfamoyl)-4- | |
| | fluorobenzamide | |
| 1.187 | 5-[3-amino-3,6-dihydro-2,6-dioxo- | — |
| | 4-(trifluoromethyl)-1(2H)-pyrimidinyl]- | |
| | 2-chloro-N-(dimethylsulfamoyl)-4- | |
| | fluorobenzamide | |
| 1.188 | 2-chloro-5-[3,6-dihydro-3-methyl- | — |
| | 2,6-dioxo-4-(trifluoromethyl)- | |
| | 1(2H)-pyrimidinyl]-N-[(ethyl)- | |
| | methylsulfamoyl]-4-fluorobenzamide | |
| 1.189 | 5-[3-amino-3,6-dihydro-2,6-dioxo- | — |
| | 4-(trifluoromethyl)-1(2H)- | |
| | pyrimidinyl]-2-chloro-N-[(ethyl)- | |
| | methylsulfamoyl]-4-fluorobenzamide | |
| 1.190 | 2-chloro-5-[3,6-dihydro-3-methyl-2, | — |
| | 6-dioxo-4-(trifluoromethyl)- | |
| | 1(2H)-pyrimidinyl]-4-fluoro-N- | |
| | [(methyl)propylsulfamoyl]benzamide | |
| 1.191 | 5-[3-amino-3,6-dihydro-2,6-dioxo- | — |
| | 4-(trifluoromethyl)-1(2H)- | |
| | pyrimidinyl]-2-chloro-4-fluoro-N- | |
| | [(methyl)propylsulfamoyl]benzamide | |
| 1.192 | 2-chloro-5-[3,6-dihydro-3-methyl-2, | — |
| | 6-dioxo-4-(trifluoromethyl)- | |
| | 1(2H)-pyrimidinyl]-4-fluoro-N- | |
| | [(isopropyl)methylsulfamoyl]- | |
| | benzamide | |
| 1.193 | 5-[3-amino-3,6-dihydro-2,6-dioxo- | — |
| | 4-(trifluoromethyl)-1(2H)- | |
| | pyrimidinyl]-2-chloro-4-fluoro-N- | |
| | [(isopropyl)methylsulfamoyl]- | |
| | benzamide | |
| 1.194 | N-[(butyl)methylsulfamoyl]-2- | — |
| | chloro-5-[3,6-dihydro-3-methyl- | |
| | 2,6-dioxo-4-(trifluoromethyl)- | |
| | 1(2H)-pyrimidinyl]-4- | |
| | fluorobenzamide | |
| 1.195 | 5-[3-amino-3,6-dihydro-2,6-dioxo- | — |
| | 4-(trifluoromethyl)-1(2H)- | |
| | pyrimidinyl]-N-[(butyl)- | |
| | methylsulfamoyl]-2-chloro-4- | |
| | fluorobenzamide | |
| 1.196 | 2-chloro-5-[3,6-dihydro-3-methyl-2, | — |
| | 6-dioxo-4-(trifluoromethyl)- | |
| | 1(2H)-pyrimidinyl]-4-fluoro-N- | |
| | [(isobutyl)methylsulfamoyl]- | |
| | benzamide | |
| 1.197 | 5-[3-amino-3,6-dihydro-2,6-dioxo- | — |
| | 4-(trifluoromethyl)-1(2H)- | |
| | pyrimidinyl]-2-chloro-4-fluoro-N- | |
| | [(isobutyl)methylsulfamoyl]- | |
| | benzamide | |
| 1.198 | norflurazone | — |
| 1.199 | diflufenican | — |
| 1.200 | picolinafen | — |
| 1.201 | beflubutamid | — |
| 1.202 | fluridone | — |
| 1.203 | flurochloridone | — |
| 1.204 | flurtamone | — |
| 1.205 | mesotrione | — |
| 1.206 | sulcotrione | — |
| 1.207 | isoxachlortole | — |
| 1.208 | isoxaflutole | — |
| 1.209 | benzofenap | — |
| 1.210 | pyrazolynate | — |
| 1.211 | pyrazoxyfen | — |
| 1.212 | benzobicyclon | — |
| 1.213 | clomazone | — |
| 1.214 | [2-chloro-3-(4,5-dihydro-3- | — |
| | isoxazolyl)-4-(methylsulfonyl)- | |
| | phenyl](5-hydroxy-1-methyl-1H- | |
| | pyrazol-4-yl)methanone | |
| 1.215 | [3-(4,5-dihydro-3-isoxazolyl)-2- | — |
| | methy1-4-(methylsulfonyl)phenyl]- | |
| | (5-hydroxy-1-methyl-1H-pyrazol-4- | |
| | yl)methanone | |
| 1.216 | [2-chloro-3-(3-methyl-5- | — |
| | isoxazolyl)-4-(methylsulfonyl)- | |
| | phenyl](5-hydroxy-1-methyl-1H- | |
| | pyrazol-4-yl)methanone | |
| 1.217 | (5-hydroxy-1-methyl-1H-pyrazol-4- | — |
| | yl)[2-methyl-3-(3-methyl-5- | |
| | isoxazolyl)-4-(methylsulfonyl)- | |
| | phenyl]methanone | |
| 1.218 | glyphosate | — |
| 1.219 | glufosinate | — |
| 1.220 | benfluralin | — |
| 1.221 | butralin | — |
| 1.222 | dinitramine | — |
| 1.223 | ethalfluralin | — |
| 1.224 | oryzalin | — |
| 1.225 | pendimethalin | — |
| 1.226 | trifluralin | — |
| 1.227 | propyzamide | — |
| 1.228 | acetochlor | — |
| 1.229 | acetochlor | dichlormid |
| 1.230 | acetochlor | furilazole |
| 1.231 | acetochlor | oxabetrinil |
| 1.232 | acetochlor | fluxofenim |
| 1.233 | acetochlor | benoxacor |
| 1.234 | acetochlor | fenclorim |
| 1.235 | alachlor | — |
| 1.236 | butachlor | — |
| 1.237 | butachlor | dichlormid |
| 1.238 | butachlor | furilazole |
| 1.239 | butachlor | oxabetrinil |
| 1.240 | butachlor | fluxofenim |
| 1.241 | butachlor | benoxacor |
| 1.242 | butachlor | fenclorim |
| 1.243 | dimethenamid | — |
| 1.244 | dimethenamid | dichlormid |
| 1.245 | dimethenamid | furilazole |
| 1.246 | dimethenamid | oxabetrinil |
| 1.247 | dimethenamid | fluxofenim |
| 1.248 | dimethenamid | benoxacor |
| 1.249 | dimethenamid | fenclorim |
| 1.250 | dimethenamid-P | — |
| 1.251 | dimethenamid-P | dichlormid |
| 1.252 | dimethenamid-P | furilazole |
| 1.253 | dimethenamid-P | oxabetrinil |
| 1.254 | dimethenamid-P | fluxofenim |
| 1.255 | dimethenamid-P | benoxacor |
| 1.256 | dimethenamid-P | fenclorim |
| 1.257 | metazachlor | — |
| 1.258 | metolachlor | — |
| 1.259 | metolachlor | dichlormid |
| 1.260 | metolachlor | furilazole |
| 1.261 | metolachlor | oxabetrinil |
| 1.262 | metolachlor | fluxofenim |
| 1.263 | metolachlor | benoxacor |
| 1.264 | metolachlor | fenclorim |
| 1.265 | S-metolachlor | — |
| 1.266 | S-metolachlor | dichlormid |
| 1.267 | S-metolachlor | furilazole |
| 1.268 | S-metolachlor | oxabetrinil |
| 1.269 | S-metolachlor | fluxofenim |
| 1.270 | S-metolachlor | benoxacor |
| 1.271 | S-metolachlor | fenclorim |
| 1.272 | pethoxamid | — |
| 1.273 | pretilachlor | — |
| 1.274 | pretilachlor | dichlormid |
| 1.275 | pretilachlor | furilazole |
| 1.276 | pretilachlor | oxabetrinil |
| 1.277 | pretilachlor | fluxofenim |
| 1.278 | pretilachlor | benoxacor |
| 1.279 | pretilachlor | fenclorim |
| 1.280 | flupoxam | — |
| 1.281 | propachlor | — |
| 1.282 | propisochlor | — |
| 1.283 | thenylchlor | — |
| 1.284 | flufenacet | — |
| 1.285 | mefenacet | — |
| 1.286 | fentrazamide | — |
| 1.287 | cafenstrole | — |
| 1.288 | indanofan | — |
| 1.289 | dichlobenil | — |
| 1.290 | chlorthiamid | — |
| 1.291 | isoxaben | — |
| 1.292 | 2,4-D | — |
| 1.293 | 2,4-DB | — |
| 1.294 | dichlorprop | — |
| 1.295 | dichlorprop-P | — |
| 1.296 | MCPA | — |
| 1.297 | MCPB | — |
| 1.298 | mecoprop | — |
| 1.299 | mecoprop-P | — |
| 1.300 | dicamba | — |
| 1.301 | quinclorac | — |
| 1.302 | quinmerac | — |
| 1.303 | clopyralid | — |
| 1.304 | fluroxypyr | — |
| 1.305 | picloram | — |
| 1.306 | triclopyr | — |
| 1.307 | benazolin | — |
| 1.308 | diflufenzopyr | — |
| 1.309 | bromobutide | — |
| 1.310 | cinmethylin | — |
| 1.311 | methyldymron | — |
| 1.312 | oxaziclomefone | — |
| 1.313 | triaziflam | — |
| 1.314 | — | benoxacor |
| 1.315 | — | cloquintocet |
| 1.316 | — | cyometrinil |
| 1.317 | — | dichlormid |
| 1.318 | — | dicyclonon |
| 1.319 | — | dietholate |
| 1.320 | — | fenchlorazole |
| 1.321 | — | fenclorim |
| 1.322 | — | flurazole |
| 1.323 | — | fluxofenim |
| 1.324 | — | furilazole |
| 1.325 | — | isoxadifen |
| 1.326 | — | mefenpyr |
| 1.327 | — | mephenate |
| 1.328 | — | naphthalic |
| | | anhydride |
| 1.329 | — | oxabetrinil |
| 1.330 | — | 2,2,5-trimethyl- |
| | | 3-(chloroacetyl)- |
| | | oxazolidine |
| 1.331 | 4-(3-trifluoromethylphenoxy)-2-(4- | — |
| | trifluoromethylphenyl)pyrimidine | |
| 1.332 | 2-chloro-5-[3,6-dihydro-3-methyl- | — |
| | 2,6-dioxo-4-(trifluoromethyl)- | |
| | 1(2H)-pyrimidinyl]-N- | |
| | (dimethylsulfamoyl)benzamide | |
| 1.333 | 5-[3-amino-3,6-dihydro-2,6-dioxo- | — |
| | 4-(trifluoromethyl)-1(2H)- | |
| | pyrimidinyl]-2-chloro-N- | |
| | (dimethylsulfamoyl)benzamide | |
| 1.334 | 2-chloro-5-[3,6-dihydro-3-methyl- | — |
| | 2,6-dioxo-4-(trifluoromethyl)- | |
| | 1(2H)-pyrimidinyl]-N-[(ethyl)- | |
| | methylsulfamoyl]benzamide | |
| 1.335 | 5-[3-amino-3,6-dihydro-2,6-dioxo- | — |
| | 4-(trifluoromethyl)-1(2H)- | |
| | pyrimidinyl]-2-chloro-N- | |
| | [(ethyl)methylsulfamoyl]benzamide | |
| 1.336 | 2-chloro-5-[3,6-dihydro-3-methyl- | — |
| | 2,6-dioxo-4-(trifluoromethyl)- | |
| | 1(2H)-pyrimidinyl]-N-[(methyl)- | |
| | propylsulfamoyl]benzamide | |
| 1.337 | 5-[3-amino-3,6-dihydro-2,6-dioxo- | — |
| | 4-(trifluoromethyl)-1(2H)- | |
| | pyrimidinyl]-2-chloro-N- | |
| | [(methyl)propylsulfamoyl]benzamide | |
| 1.338 | 2-chloro-5-[3,6-dihydro-3-methyl- | — |
| | 2,6-dioxo-4-(trifluoromethyl)- | |
| | 1(2H)-pyrimidinyl]-N- | |
| | [(isopropyl)methylsulfamoyl]- | |
| | benzamide | |
| 1.339 | 5-[3-amino-3,6-dihydro-2,6-dioxo- | — |
| | 4-(trifluoromethyl)-1(2H)- | |
| | pyrimidinyl]-2-chloro-N- | |
| | [(isopropyl)methylsulfamoyl]- | |
| | benzamide | |
| 1.340 | N-[(butyl)methylsulfamoyl]-2- | — |
| | chloro-5-[3,6-dihydro-3-methyl- | |
| | 2,6-dioxo-4-(trifluoromethyl)- | |
| | 1(2H)-pyrimidinyl]benzamide | |
| 1.341 | 5-[3-amino-3,6-dihydro-2,6-dioxo- | — |
| | 4-(trifluoromethyl)-1(2H)- | |
| | pyrimidinyl]-N-[(butyl)- | |
| | methylsulfamoyl]-2-chlorobenzamide | |
| 1.342 | 2-chloro-5-[3,6-dihydro-3-methyl- | — |
| | 2,6-dioxo-4-(trifluoromethyl)- | |
| | 1(2H)-pyrimidinyl]-N- | |
| | [(isobutyl)methylsulfamoyl]- | |
| | benzamide | |
| 1.343 | 5-[3-amino-3,6-dihydro-2,6-dioxo- | — |
| | 4-(trifluoromethyl)-1(2H)- | |
| | pyrimidinyl]-2-chloro-N- | |
| | [(isobutyl)methylsulfamoyl]- | |
| | benzamide | |
| 1.344 | acetochlor | 2,2,5-trimethyl- |
| | | 3-(dichloro- |
| | | acetyl)-1,3-oxa- |
| | | zolidine |
| 1.345 | butachlor | 2,2,5-trimethyl- |
| | | 3-(dichloro- |
| | | acetyl)-1,3- |
| | | oxazolidine |
| 1.346 | dimethenamid | 2,2,5-trimethyl- |
| | | 3-(dichloro- |
| | | acetyl)-1,3-oxa- |
| | | zolidine |
| 1.347 | dimethenamid-P | 2,2,5-trimethyl- |
| | | 3-(dichloro- |
| | | acetyl)-1,3-oxa- |
| | | zolidine |
| 1.348 | metolachlor | 2,2,5-trimethyl- |
| | | 3-(dichloro- |
| | | acetyl)-1,3-oxa- |
| | | zolidine |
| 1.349 | S-metolachlor | 2,2,5-trimethyl- |
| | | 3-(dichloro- |
| | | acetyl)-1,3-oxa- |
| | | zolidine |
| 1.350 | pretilachlor | 2,2,5-trimethyl- |
| | | 3-(dichloro- |
| | | acetyl)-1,3-oxa- |
| | | zolidine |
| 1.351 | pethoxamid | 2,2,5-trimethyl- |
| | | 3-(dichloro- |
| | | acetyl)-1,3-oxa- |
| | | zolidine |
| 1.352 | pethoxamid | dichlormid |
| 1.353 | pethoxamid | furilazole |
| 1.354 | pethoxamid | oxabetrinil |
| 1.355 | pethoxamid | fluxofenim |
| 1.356 | pethoxamid | benoxacor |
| 1.357 | pethoxamid | fenclorim |
| 1.358 | pethoxamid | 4-(dichloro- |
| | | acetyl)-1-oxa-4- |
| | | azaspiro[4.5]- |
| | | decane |
| 1.359 | acetochlor | 4-(dichloro- |
| | | acetyl)-1-oxa-4- |
| | | azaspiro[4.5]- |
| | | decane |
| 1.360 | butachlor | 4-(dichloro- |
| | | acetyl)-1-oxa-4- |
| | | azaspiro[4.5]- |
| | | decane |
| 1.361 | dimethenamid | 4-(dichloro- |
| | | acetyl)-1-oxa-4- |
| | | azaspiro[4.5]- |
| | | decane |
| 1.362 | dimethenamid-P | 4-(dichloro- |
| | | acetyl)-1-oxa-4- |
| | | azaspiro[4.5]- |
| | | decane |
| 1.363 | metolachlor | 4-(dichloro- |
| | | acetyl)-1-oxa-4- |
| | | azaspiro[4.5]- |
| | | decane |
| 1.364 | S-metolachlor | 4-(dichloro- |
| | | acetyl)-1-oxa-4- |
| | | azaspiro[4.5]- |
| | | decane |
| 1.365 | pretilachlor | 4-(dichloro- |
| | | acetyl)-1-oxa-4- |
| | | azaspiro[4.5]- |
| | | decane |
| 1.366 | metamifop | — |
| 1.367 | metamifop | cloquintocet |
| 1.368 | metamifop | fenchlorazole |
| 1.369 | metamifop | isoxadifen |
| 1.370 | metamifop | mefenpyr |

If the active compounds mentioned in Table 2 have ionizable functional groups, preference is also given to those mixtures in which the active compounds listed are in each case replaced by their agriculturally acceptable salts, in particular, in the case of compounds which can be deprotonated, by their lithium, sodium, potassium, calcium, magnesium, ammonium, methylammonium, isopropylammonium, dimethylammonium, diisopropylammonium, trimethylammonium, 2-hydroxyethylammonium, 2-(2-hydroxyeth-1-oxy)eth-1-ylammonium, di-(2-hydroxyethyl)ammonium or trimethylsulfonium salts and also, in the case of protonatable or cationic compounds, by their chloride, bromide, hydrogensulfate, methylsulfate, sulfate, dihydrogenphosphate or hydrogenphosphate salts or acid addition salts. If the active compounds mentioned in Table 2 have a carboxyl group, preference is also given to those mixtures where the active compounds listed are in each case replaced by their agriculturally acceptable derivatives, in particular their methyl- or dimethylamides, their anilides or 2-chloroanilides, their methyl, ethyl, propyl, isopropyl, butyl, isobutyl, pentyl, mexyl, isooctyl, methoxyethyl, ethoxyethyl or butoxyethyl esters or their thioethyl esters.

Preference is also given to the compositions 2.1-2.370 which differ from the corresponding compositions 1.1-1.370 only in that the 7-pyrazolylbenzoxazole I.1 is replaced by the 7-pyrazolylbenzoxazole I.2.

Preference is also given to the compositions 3.1-3.370 which differ from the corresponding compositions 1.1-1.370 only in that the 7-pyrazolylbenzoxazole I.1 is replaced by the 7-pyrazolylbenzoxazole I.3.

Preference is also given to the compositions 4.1-4.370 which differ from the corresponding compositions 1.1-1.370 only in that the 7-pyrazolylbenzoxazole I.1 is replaced by the 7-pyrazolylbenzoxazole I.4.

Preference is also given to the compositions 5.1-5.370 which differ from the corresponding compositions 1.1-1.370 only in that the 7-pyrazolylbenzoxazole I.1 is replaced by the 7-pyrazolylbenzoxazole I.5.

Preference is also given to the compositions 6.1-6.370 which differ from the corresponding compositions 1.1-1.370 only in that the 7-pyrazolylbenzoxazole I.1 is replaced by the 7-pyrazolylbenzoxazole I.6.

Preference is also given to the compositions 7.1-7.370 which differ from the corresponding compositions 1.1-1.370 only in that the 7-pyrazolylbenzoxazole I.1 is replaced by the 7-pyrazolylbenzoxazole I.7.

Preference is also given to the compositions 8.1-8.370 which differ from the corresponding compositions 1.1-1.370 only in that the 7-pyrazolylbenzoxazole I.1 is replaced by the 7-pyrazolylbenzoxazole I.8.

Preference is also given to the compositions 9.1-9.370 which differ from the corresponding compositions 1.1-1.370 only in that the 7-pyrazolylbenzoxazole I.1 is replaced by the 7-pyrazolylbenzoxazole I.9.

Preference is also given to the compositions 10.1-10.370 which differ from the corresponding compositions 1.1-1.370 only in that the 7-pyrazolylbenzoxazole I.1 is replaced by the 7-pyrazolylbenzoxazole I.10.

Preference is also given to the compositions 11.1-11.370 which differ from the corresponding compositions 1.1-1.370 only in that the 7-pyrazolylbenzoxazole I.1 is replaced by the 7-pyrazolylbenzoxazole I.11.

Preference is also given to the compositions 12.1-12.370 which differ from the corresponding compositions 1.1-1.370 only in that the 7-pyrazolylbenzoxazole I.1 is replaced by the 7-pyrazolylbenzoxazole I.12.

Preference is also given to the compositions 13.1-13.370 which differ from the corresponding compositions 1.1-1.370 only in that the 7-pyrazolylbenzoxazole I.1 is replaced by the 7-pyrazolylbenzoxazole I.13.

Preference is also given to the compositions 14.1-14.370 which differ from the corresponding compositions 1.1-1.370 only in that the 7-pyrazolylbenzoxazole I.1 is replaced by the 7-pyrazolylbenzoxazole I.14.

Preference is also given to the compositions 15.1-15.370 which differ from the corresponding compositions 1.1-1.370 only in that the 7-pyrazolylbenzoxazole I.1 is replaced by the 7-pyrazolylbenzoxazole I.15.

Preference is also given to the compositions 16.1-16.370 which differ from the corresponding compositions 1.1-1.370 only in that the 7-pyrazolylbenzoxazole I.1 is replaced by the 7-pyrazolylbenzoxazole I.16.

Preference is also given to the compositions 17.1-17.370 which differ from the corresponding compositions 1.1-1.370 only in that the 7-pyrazolylbenzoxazole I.1 is replaced by the 7-pyrazolylbenzoxazole 1.17.

Preference is also given to the compositions 18.1-18.370 which differ from the corresponding compositions 1.1-1.370 only in that the 7-pyrazolylbenzoxazole 1.1 is replaced by the 7-pyrazolylbenzoxazole I.18.

Preference is also given to the compositions 19.1-19.370 which differ from the corresponding compositions 1.1-1.370 only in that the 7-pyrazolylbenzoxazole I.1 is replaced by the 7-pyrazolylbenzoxazole I.19.

Preference is also given to the compositions 20.1-20.370 which differ from the corresponding compositions 1.1-1.370 only in that the 7-pyrazolylbenzoxazole I.1 is replaced by the 7-pyrazolylbenzoxazole I.20.

Preference is also given to the compositions 21.1-21.370 which differ from the corresponding compositions 1.1-1.370 only in that the 7-pyrazolylbenzoxazole I.1 is replaced by the 7-pyrazolylbenzoxazole I.21.

Preference is also given to the compositions 22.1-22.370 which differ from the corresponding compositions 1.1-1.370 only in that the 7-pyrazolylbenzoxazole I.1 is replaced by the 7-pyrazolylbenzoxazole I.22.

Preference is also given to the compositions 23.1-23.370 which differ from the corresponding compositions 1.1-1.370 only in that the 7-pyrazolylbenzoxazole I.1 is replaced by the 7-pyrazolylbenzoxazole I.23.

Preference is also given to the compositions 24.1-24.370 which differ from the corresponding compositions 1.1-1.370 only in that the 7-pyrazolylbenzoxazole I.1 is replaced by the 7-pyrazolylbenzoxazole I.24.

Preference is also given to the compositions 25.1-25.370 which differ from the corresponding compositions 1.1-1.370 only in that the 7-pyrazolylbenzoxazole I.1 is replaced by the 7-pyrazolylbenzoxazole I.25.

Preference is also given to the compositions 26.1-26.370 which differ from the corresponding compositions 1.1-1.370 only in that the 7-pyrazolylbenzoxazole I.1 is replaced by the 7-pyrazolylbenzoxazole I.26.

Preference is also given to the compositions 27.1-27.370 which differ from the corresponding compositions 1.1-1.370 only in that the 7-pyrazolylbenzoxazole I.1 is replaced by the 7-pyrazolylbenzoxazole I.27.

Preference is also given to the compositions 28.1-28.370 which differ from the corresponding compositions 1.1-1.370 only in that the 7-pyrazolylbenzoxazole I.1 is replaced by the 7-pyrazolylbenzoxazole I.28.

Preference is also given to the compositions 29.1-29.370 which differ from the corresponding compositions 1.1-1.370 only in that the 7-pyrazolylbenzoxazole 1.1 is replaced by the 7-pyrazolylbenzoxazole I.29.

Preference is also given to the compositions 30.1-30.370 which differ from the corresponding compositions 1.1-1.370 only in that the 7-pyrazolylbenzoxazole I.1 is replaced by the 7-pyrazolylbenzoxazole I.30.

Preference is also given to the compositions 31.1-31.370 which differ from the corresponding compositions 1.1-1.370 only in that the 7-pyrazolylbenzoxazole I.1 is replaced by the 7-pyrazolylbenzoxazole I.31.

Preference is also given to the compositions 32.1-32.370 which differ from the corresponding compositions 1.1-1.370 only in that the 7-pyrazolylbenzoxazole I.1 is replaced by the 7-pyrazolylbenzoxazole I.32.

Preference is also given to the compositions 33.1-33.370 which differ from the corresponding compositions 1.1-1.370 only in that the 7-pyrazolylbenzoxazole I.1 is replacedby the 7-pyrazolylbenzoxazole I.33.

Preference is also given to the compositions 34.1-34.370 which differ from the corresponding compositions 1.1-1.370 only in that the 7-pyrazolylbenzoxazole I.1 is replaced by the 7-pyrazolylbenzoxazole I.34.

Preference is also given to the compositions 35.1-35.370 which differ from the corresponding compositions 1.1-1.370 only in that the 7-pyrazolylbenzoxazole I.1 is replaced by the 7-pyrazolylbenzoxazole I.35.

Preference is also given to the compositions 36.1-36.370 which differ from the corresponding compositions 1.1-1.370 only in that the 7-pyrazolylbenzoxazole I.1 is replaced by the 7-pyrazolylbenzoxazole I.36.

Preference is also given to the compositions 37.1-37.370 which differ from the corresponding compositions 1.1-1.370 only in that the 7-pyrazolylbenzoxazole I.1 is replaced by the 7-pyrazolylbenzoxazole I.37.

Preference is also given to the compositions 38.1-38.370 which differ from the corresponding compositions 1.1-1.370 only in that the 7-pyrazolylbenzoxazole I.1 is replaced by the 7-pyrazolylbenzoxazole I.38.

Preference is also given to the compositions 39.1-39.370 which differ from the corresponding compositions 1.1-1.370 only in that the 7-pyrazolylbenzoxazole I.1 is replaced by the 7-pyrazolylbenzoxazole I.39.

Preference is also given to the compositions 40.1-40.370 which differ from the corresponding compositions 1.1-1.370 only in that the 7-pyrazolylbenzoxazole I.1 is replaced by the 7-pyrazolylbenzoxazole I.40.

Preference is also given to the compositions 41.1-41.370 which differ from the corresponding compositions 1.1-1.370 only in that the 7-pyrazolylbenzoxazole I.1 is replaced by the 7-pyrazolylbenzoxazole I.41.

Preference is also given to the compositions 42.1-42.370 which differ from the corresponding compositions 1.1-1.370 only in that the 7-pyrazolylbenzoxazole I.1 is replaced by the 7-pyrazolylbenzoxazole I.42.

Preference is also given to the compositions 43.1-43.370 which differ from the corresponding compositions 1.1-1.370 only in that the 7-pyrazolylbenzoxazole I.1 is replaced by the 7-pyrazolylbenzoxazole I.43.

Preference is also given to the compositions 44.1-44.370 which differ from the corresponding compositions 1.1-1.370 only in that the 7-pyrazolylbenzoxazole I.1 is replaced by the 7-pyrazolylbenzoxazole I.44.

Preference is also given to the compositions 45.1-45.370 which differ from the corresponding compositions 1.1-1.370 only in that the 7-pyrazolylbenzoxazole 1.1 is replaced by the 7-pyrazolylbenzoxazole I.45.

Preference is also given to the compositions 46.1-46.370 which differ from the corresponding compositions 1.1-1.370 only in that the 7-pyrazolylbenzoxazole I.1 is replaced by the 7-pyrazolylbenzoxazole I.46.

Preference is also given to the compositions 47.1-47.370 which differ from the corresponding compositions 1.1-1.370 only in that the 7-pyrazolylbenzoxazole I.1 is replaced by the 7-pyrazolylbenzoxazole I.47.

Preference is also given to the compositions 48.1-48.370 which differ from the corresponding compositions 1.1-1.370 only in that the 7-pyrazolylbenzoxazole I.1 is replaced by the 7-pyrazolylbenzoxazole I.48.

Preference is also given to the compositions 49.1-49.370 which differ from the corresponding compositions 1.1-1.370 only in that the 7-pyrazolylbenzoxazole I.1 is replaced by the 7-pyrazolylbenzoxazole I.49.

Preference is also given to the compositions 50.1-50.370 which differ from the corresponding compositions 1.1-1.370 only in that the 7-pyrazolylbenzoxazole I.1 is replaced by the 7-pyrazolylbenzoxazole I.50.

Preference is also given to the compositions 51.1-51.370 which differ from the corresponding compositions 1.1-1.370 only in that the 7-pyrazolylbenzoxazole I.1 is replaced by the 7-pyrazolylbenzoxazole I.51.

Preference is also given to the compositions 52.1-52.370 which differ from the corresponding compositions 1.1-1.370 only in that the 7-pyrazolylbenzoxazole I.1 is replaced by the 7-pyrazolylbenzoxazole I.52.

Preference is also given to the compositions 53.1-53.370 which differ from the corresponding compositions 1.1-1.370 only in that the 7-pyrazolylbenzoxazole I.1 is replaced by the 7-pyrazolylbenzoxazole 1.53.

Preference is also given to the compositions 54.1-54.370 which differ from the corresponding compositions 1.1-1.370 only in that the 7-pyrazolylbenzoxazole 1.1 is replaced by the 7-pyrazolylbenzoxazole I.54.

Preference is also given to the compositions 55.1-55.370 which differ from the corresponding compositions 1.1-1.370 only in that the 7-pyrazolylbenzoxazole I.1 is replaced by the 7-pyrazolylbenzoxazole I.55.

Preference is also given to the compositions 56.1-56.370 which differ from the corresponding compositions 1.1-1.370 only in that the 7-pyrazolylbenzoxazole I.1 is replaced by the 7-pyrazolylbenzoxazole I.56.

Preference is also given to the compositions 57.1-57.370 which differ from the corresponding compositions 1.1-1.370 only in that the 7-pyrazolylbenzoxazole I.1 is replaced by the 7-pyrazolylbenzoxazole I.57.

Preference is also given to the compositions 58.1-58.370 which differ from the corresponding compositions 1.1-1.370 only in that the 7-pyrazolylbenzoxazole I.1 is replaced by the 7-pyrazolylbenzoxazole I.58.

Preference is also given to the compositions 59.1-59.370 which differ from the corresponding compositions 1.1-1.370 only in that the 7-pyrazolylbenzoxazole I.1 is replaced by the 7-pyrazolylbenzoxazole I.59.

Preference is also given to the compositions 60.1-60.370 which differ from the corresponding compositions 1.1-1.370 only in that the 7-pyrazolylbenzoxazole I.1 is replaced by the 7-pyrazolylbenzoxazole I.60.

Preference is also given to the compositions 61.1-61.370 which differ from the corresponding compositions 1.1-1.370 only in that the 7-pyrazolylbenzoxazole I.1 is replaced by the 7-pyrazolylbenzoxazole I.61.

Preference is also given to the compositions 62.1-62.370 which differ from the corresponding compositions 1.1-1.370 only in that the 7-pyrazolylbenzoxazole I.1 is replaced by the 7-pyrazolylbenzoxazole 1.62.

Preference is also given to the compositions 63.1-63.370 which differ from the corresponding compositions 1.1-1.370 only in that the 7-pyrazolylbenzoxazole I.1 is replaced by the 7-pyrazolylbenzoxazole I.63.

Preference is also given to the compositions 64.1-64.370 which differ from the corresponding compositions 1.1-1.370 only in that the 7-pyrazolylbenzoxazole I.1 is replaced by the 7-pyrazolylbenzoxazole I.64.

Preference is also given to the compositions 65.1-65.370 which differ from the corresponding compositions 1.1-1.370 only in that the 7-pyrazolylbenzoxazole I.1 is replaced by the 7-pyrazolylbenzoxazole I.65.

Preference is also given to the compositions 66.1-66.370 which differ from the corresponding compositions 1.1-1.370 only in that the 7-pyrazolylbenzoxazole I.1 is replaced by the 7-pyrazolylbenzoxazole I.66.

Preference is also given to the compositions 67.1-67.370 which differ from the corresponding compositions 1.1-1.370 only in that the 7-pyrazolylbenzoxazole I.1 is replaced by the 7-pyrazolylbenzoxazole I.67.

Preference is also given to the compositions 68.1-68.370 which differ from the corresponding compositions 1.1-1.370 only in that the 7-pyrazolylbenzoxazole I.1 is replaced by the 7-pyrazolylbenzoxazole I.68.

Preference is also given to the compositions 69.1-69.370 which differ from the corresponding compositions 1.1-1.370 only in that the 7-pyrazolylbenzoxazole I.1 is replaced by the 7-pyrazolylbenzoxazole I.69.

Preference is also given to the compositions 70.1-70.370 which differ from the corresponding compositions 1.1-1.370 only in that the 7-pyrazolylbenzoxazole I.1 is replaced by the 7-pyrazolylbenzoxazole I.70.

Preference is also given to the compositions 71.1-71.370 which differ from the corresponding compositions 1.1-1.370 only in that the 7-pyrazolylbenzoxazole I.1 is replaced by the 7-pyrazolylbenzoxazole I.71.

Preference is also given to the compositions 72.1-72.370 which differ from the corresponding compositions 1.1-1.370 only in that the 7-pyrazolylbenzoxazole I.1 is replaced by the 7-pyrazolylbenzoxazole I.72.

Reference is also given to the compositions 73.1-73.370 which differ from the corresponding compositions 1.1-1.370 only in that the 7-pyrazolylbenzoxazole I.1 is replaced by the 7-pyrazolylbenzoxazole I.73.

Reference is also given to the compositions 74.1-74.370 which differ from the corresponding compositions 1.1-1.370 only in that the 7-pyrazolylbenzoxazole I.1 is replaced by the 7-pyrazolylbenzoxazole I.74.

Reference is also given to the compositions 75.1-75.370 which differ from the corresponding compositions 1.1-1.370 only in what the 7-pyrazolylbenzoxazole I.1 is replaced by the 7-pyrazolylbenzoxazole I.75.

Preference is also given to the compositions 76.1-76.370 which differ from the corresponding compositions 1.1-1.370 only in that the 7-pyrazolylbenzoxazole I.1 is replaced by the 7-pyrazolylbenzoxazole I.76.

The weight ratios of the individual components in the compositions 2.1 to 76.343 are within the limits stated above, in the case of binary mixtures of 7-pyrazolylbenzoxazole I.1 and herbicide B) for example 1:1, 1:2 or 1:5, in the case of binary mixtures of 7-pyrazolylbenzoxazole I.1 and safener C for example 1:1, 1:2 or 1:5 and in the case of ternary mixtures of 7-pyrazolylbenzoxazole I.1, herbicide B and safener C for example 1:1:1, 2:1:1, 1:2:1, 1:5:1 or 1:5:2.

In the ready-to-use preparations, i.e. in the compositions according to the invention in the form of crop protection products, the components A and B and/or C, in suspended, emulsified or dissolved form, can be present formulated jointly or separately. The use forms depend entirely on the intended use.

The compositions according to the invention can be applied, for example, in the form of directly sprayable aqueous solutions, powders, suspensions, also highly-concentrated aqueous, oily or other suspensions or dispersions, emulsions, oil dispersions, pastes, dusts, materials for spreading or granules, by means of spraying, atomizing, dusting, broadcasting or watering. The use forms depend on the intended use; in any case, they should ensure the finest possible distribution of the active compounds.

Depending on the form in which the ready-to-use preparations are present in the compositions according to the invention, they comprise one or more liquid or solid carriers, if appropriate surfactants and if appropriate further auxiliaries which are customary for formulating crop protection products. The person skilled in the art is sufficiently familiar with the recipes for such formulations.

The ready-to-use preparations comprise the components A and B and/or C and auxiliaries which are customary for formulating crop protection products, which auxiliaries may also comprise a liquid carrier.

Suitable inert auxiliaries with carrier function are essentially:

mineral oil fractions of medium to high boiling point, such as kerosine and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water.

Aqueous use forms can be prepared from emulsion concentrates, suspensions, pastes, wettable powders or water-dispersible granules by adding water. To prepare emulsions, pastes or oil dispersions, the active compounds A) to C), as such or dissolved in an oil or solvent, can be homogenized in water by means of wetting agent, tackifier, dispersant or emulsifier. Alternatively, it is also possible to prepare concentrates consisting of active substance, wetting agent, tackifier, dispersant or emulsifier and, if desired, solvent or oil, and these concentrates are suitable for dilution with water.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, of alkyl- and alkylarylsulfonates, of alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ether, tributylphenyl polyglycol ether, alkylaryl polyether alcohols, isotridecyl alcohol, fatty alcohol/ethylene oxide condensates, ethoxylated castor oil, polyoxyethylene alkyl ether or polyoxypropylene alkyl ether, lauryl alcohol polyglycol ether acetate, sorbitol esters, lignosulfite waste liquors or methylcellulose.

Powders, materials for spreading and dusts can be prepared by mixing or concomitantly grinding the active substances with a solid carrier.

Granules, e.g. coated granules, impregnated granules and homogeneous granules, can be prepared by binding the active compounds to solid carriers. Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

The concentrations of the active compounds in the ready-to-use preparations can be varied within wide ranges. In general, the formulations comprise approximately from 0.001 to 98% by weight, preferably 0.01 to 95% by weight, of active compounds. The active compounds are employed in a purity of from 90% to 100%, preferably 95% to 100% (according to NMR spectrum).

The compositions according to the invention can, for example, be formulated as follows:
I 20 parts by weight of the active compound or active compound mixture in question are dissolved in a mixture composed of 80 parts by weight of alkylated benzene, 10 parts by weight of the adduct of 8 to 10 mol of ethylene oxide to 1 mol of oleic acid N-monoethanolamide, 5 parts by weight of calcium dodecylbenzenesulfonate and 5 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active compound.
II 20 parts by weight of the active compound or active compound mixture in question are dissolved in a mixture composed of 40 parts by weight of cyclohexanone, 30 parts by weight of isobutanol, 20 parts by weight of the adduct of 7 mol of ethylene oxide to 1 mol of isooctylphenol and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active compound.
III 20 parts by weight of the active compound or active compound mixture in question are dissolved in a mixture composed of 25 parts by weight of cyclohexanone, 65 parts by weight of a mineral oil fraction of boiling point 210 to 280° C. and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active compound.
IV 20 parts by weight of the active compound or active compound mixture in question are mixed thoroughly with 3 parts by weight of sodium diisobutylnaphthalenesulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20 000 parts by weight of water gives a spray mixture which comprises 0.1% by weight of the active compound.
V 3 parts by weight of the active compound or active compound mixture in question are mixed with 97 parts by weight of finely divided kaolin. This gives a dust which comprises 3% by weight of the active compound.
VI 20 parts by weight of the active compound or active compound mixture in question are mixed intimately with 2 parts by weight of calcium dodecylbenzenesulfonate, 8 parts by weight of fatty alcohol polyglycol ether, 2 parts by weight of the sodium salt of a phenol-urea-formaldehyde condensate and 68 parts by weight of a paraffinic mineral oil. This gives a stable oily dispersion.
VII 1 part by weight of the active compound or active compound mixture in question is dissolved in a mixture composed of 70 parts by weight of cyclohexanone, 20 parts by weight of ethoxylated isooctylphenol and 10 parts by weight of ethoxylated castor oil. This gives a stable emulsion concentrate.
VIII 1 part by weight of the active compound or active compound mixture in question is dissolved in a mixture composed of 80 parts by weight of cyclohexanone and 20 parts by weight of Wettol® EM 31 (nonionic emulsifier based on ethoxylated castor oil). This gives a stable emulsion concentrate.

The components A and B and/or C can be formulated jointly or separately.

The components A and B and/or C can be applied jointly or separately, simultaneously or successively, before, during or after emergence of the plants.

If the active compounds A and B and/or C are less well tolerated by certain crop plants, it is possible to use application methods in which the herbicidal compositions are sprayed with the aid of sprayers in such a way that the leaves of the sensitive crop plants are as far as possible unaffected, whereas the active compounds reach the leaves of the undesirable plants growing underneath or the uncovered soil surface (post-directed, lay-by).

The required application rate of the pure active compound composition, i.e. of A and B and/or C without formulation auxiliary, depends on the composition of the plant stem, on the development stage of the plants, on the climatic conditions of the location where the composition is used and on the application method. In general, the application rate of A and B and/or C is from 0.001 to 3 kg/ha, preferably from 0.005 to 2 kg/ha and in particular from 0.01 to 1 kg/ha of active substance (a.s.).

The required application rates of 7-pyrazolylbenzoxazoles are generally in the range from 0.1 g/ha to 1 kg/ha and preferably in the range from 1 g/ha to 500 g/ha or from 5 g/ha to 500 g/ha of a.s.

The compositions are applied to the plants mainly by foliar spraying. Application can be carried out by customary spraying techniques using, for example, water as carrier and spray liquor rates of from about 100 to 1000 l/ha (for example from 300 to 400l/ha). Application of the herbicidal compositions by the low-volume and the ultra-low-volume method is possible, as is their application in the form of micro granules.

The compositions according to the present invention are suitable for controlling common harmful plants in useful plants, in particular in crops such as wheat, barley, oats, corn, soybean, sorghum, rice, oilseed rape, cotton, potatoes, dry beans, groundnuts or in perennial crops. In another embodiment of the invention, they are useful for controlling the whole vegetation, i.e. they act as a total weedkiller. Futhermore, in another emodiment of the present invention, the compositions are useful for controlling undesirable vegetation in forestry.

Moreover, the compositions according to the present invention are also suitable for the desiccation and/or defoliation of plants.

As desiccants, they are suitable, in particular, for desiccating the above-ground parts of crop plants such as potatoes, oilseed rape, sunflowers and soya beans. This allows completely mechanical harvesting of these important crop plants.

Also of economic interest is
the coordinated dehiscence of fruits or the reduction of their adherence to the plant, for example in citrus fruit, olives or other kinds and species of pernicious fruit, stone fruit and nuts, since this facilitates harvesting of these fruits, and also the controlled defoliation of useful plants, in particular cotton. The dehiscence which is promoted by the application of compositions according to the invention is due to the formation of abscission tissue between the fruit or leaf and shoot part of the plants. The defoliation of cotton is of very particular economic interest since it facilitates harvesting. Simultaneously, the shortening of the window within which the individual plants mature leads to increased quality of the harvested fiber material.

Moreover, it may be useful to apply the compositions according to the invention jointly as a mixture with other crop protection products, for example with pesticides or agents for controlling phytopathogenic fungi or bacteria. Also of interest is the miscibility with mineral salt solutions which are employed for treating nutritional and trace element deficiencies. Non-phytotoxic oils and oil concentrates may also be added.

The compositions according to the invention can also be used in crop plants which are resistant to one or more herbicides owing to genetic engineering or breeding or which are resistant to attack by insects owing to genetic engineering or breeding. Suitable are for example crop plants which are resistant to herbicidal EPSP synthase inhibitors, such as, for example, glyphosate, to herbicidal glutamine synthase inhibitors, such as, for example, glufosinate, to herbicidal protoporphyrinogen-IX oxidase inhibitors, such as, for example, butafenacil, or to herbicidal ALS inhibitors, such as, for example, imazamethabenz, imazamox, imazapic, imazapyr, imazaquin, imazethapyr, or crop plants which, owing to introduction of the gene for Bt toxin by genetic modification, are resistant to attack by certain insects.

Surprisingly, the compositions according to the invention which comprise at least one 7-pyrazolylbenzoxazole of the formula I and at least one herbicide B have better herbicidal activity against harmful plants than would have been expected by the herbicidal activity of the individual compounds. In other words, the joint application of 7-pyrazolylbenzoxazole I and herbicide B results in an enhanced activity against harmful plants in the sense of a synergy effect (synergism). For this reason, the mixtures can, based on the individual components, be used at lower application rates to achieve a herbicidal effect comparable to the individual components.

Surprisingly, the compositions according to the invention which, in addition to the 7-pyrazolylbenzoxazole I and, if appropriate, the herbicide B, comprise an active compound from group C are better tolerated by useful plants than the respective 7-pyrazolylbenzoxazole I or the respective mixture of 7-pyrazolylbenzoxazole+herbicide B without active compound of group C.

### USE EXAMPLES

The effect of the herbicidal mixtures according to the invention of components A and B and, if appropriate, C on the growth of undesirable plants compared to the herbicidally active compounds alone was demonstrated by the following greenhouse experiments (Examples 1 to 33):

For the post-emergence treatment, the test plants were first grown to a height of 3 to 20 cm, depending on the plant habit, and only then treated. Here, the herbicidal compositions were suspended or emulsified in water as distribution medium and sprayed using finely distributing nozzles.

For the pre-emergence treatment, the test plants were sown is pots 1-2 days later, i.e. prior to germination, the pots were sprayed with the finely distributed herbicidal compositions, which had been suspended in water.

The respective components A and B and/or C were formulated as 10% by weight strength emulsion concentrate and introduced to the spray liquor with the amount of solvent system used for applying the active compound. In the examples, the solvent used was water.

The test period extended over 21 days. During this time, the plants were tended, and their response to the treatments with active compound was evaluated.

The evaluation for the damage caused by the chemical compositions was carried out using a scale from 0 to 100%, compared to the untreated control plants. Here, 0 means no damage and 100 means complete destruction of the plants.

In the examples below, the value E which is to be expected if the activity of the individual active compounds is just additive was calculated using the method of S. R. Colby (1967) “Calculating synergistic and antagonistic responses of herbicide combinations”, Weeds 15, p. 22 ff.
E=X+Y—(X·Y/100)
where
X=effect in percent using active compound A at an application rate a;
Y=effect in percent using active compound B at an application rate b;
E=expected effect (in %) of A+B at application rates a+b.

If the value calculated in this manner is higher than the value E calculated according to Colby, a synergistic effect is present.

The plants used in the greenhouse experiments were of the following species:

| Bayer code | Scientific Name |
|---|---|
| ABUTH | velvet leaf |
| AVEFA | wild oat |
| BIDPI | hairy beggarticks |
| BRAPL | alexandergrass |
| CHEAL | lambsquarters |
| COMBE | tropical spiderwort |
| ECHCG | barnyardgrass |
| GALAP | catchweed bedstraw |
| MATIN | false chamomille |
| POAAN | annual bluegrass |
| POLPE | ladysthumb |
| SETFA | giant foxtail |
| SETVI | green foxtail |
| SORHA | johnsongrass |
| THLAR | fanweed |
| VERSS | speadwell |

The results of these tests are given in the tables of Examples 1 to 32 below and demonstrate the synergistic effect of mixtures comprising at least one 7-pyrazolylbenzoxazole I and at least one herbicide B. Example 33 demonstrates the effect of a mixture which comprises at least one 7-pyrazolylbenzoxazole I and at least one safener C.
I.9 corresponds to compound In.003 from WO 98/27090.
I.12 corresponds to compound Im.003 from WO 99/55702.
I.15 corresponds to compound In.004 from WO 99/55702.
I.18 corresponds to compound Im.005 from WO 98/27090.

### Example 1

### Synergistic Herbicidal Action of the Mixture No. 9.63, Applied by the Post-emergence Method

| Application rate in | | Herbicidal action | | Herbicidal action | |
|---|---|---|---|---|---|
| g/ha | | against AVEFA | | against SETFA | |
| | tepral- | | Calculated | | Calculated |
| 7-pyrazol- | oxydim | | using | | using |
| ylbenzox- | (from | | Colby | | Colby |
| azole I.9 | Group b1) | Found | formula | Found | formula |
| 1.95 | — | 10 | — | 45 | — |
| — | 7.81 | 70 | — | 70 | — |
| 1.95 | 7.81 | 85 | 73 | 98 | 83.5 |
| 1.95 | — | 10 | — | 45 | — |
| — | 15.63 | 80 | — | 80 | — |
| 1.95 | 15.63 | 98 | 82 | 98 | 89 |

### Example 2

### Synergistic Herbicidal Action of the Mixture No. 12.63, Applied by the Post-emergence Method

| Application rate in | | Herbicidal action | | Herbicidal action | |
|---|---|---|---|---|---|
| g/ha | | against AVEFA | | against SETFA | |
| | tepral- | | Calculated | | Calculated |
| 7-pyrazol- | oxydim | | using | | using |
| ylbenzox- | (from | | Colby | | Colby |
| azole I.12 | Group b1) | Found | formula | Found | formula |
| 1.95 | — | 20 | — | 50 | — |
| — | 15.63 | 80 | — | 80 | — |
| 1.95 | 15.63 | 100 | 84 | 98 | 90 |
| 3.91 | — | 30 | — | 65 | — |
| — | 15.63 | 80 | — | 80 | — |
| 3.91 | 15.63 | 100 | 86 | 100 | 93 |

### Example 3

### Synergistic Herbicidal Action of the Mixture No. 12.61, Applied by the Post-emergence Method

| Application rate | | Herbicidal action against | |
|---|---|---|---|
| in g/ha | | GALAP | |
| 7-pyrazolyl- | profoxydim | | Calculated using |
| benzoxazole I.12 | (from Group b1) | Found | Colby formula |
| 0.49 | — | 15 | — |
| — | 7.81 | 30 | — |
| 0.49 | 7.81 | 50 | 40.5 |
| 0.98 | — | 15 | — |
| — | 15.63 | 30 | — |
| 0.98 | 15.63 | 75 | 40.5 |

### Example 4

### Synergistic Herbicidal Action of the Mixture No. 12.111, Applied by the Post-emergence Method

| Application rate in | | | | | |
|---|---|---|---|---|---|
| g/ha | | Herbicidal action | | Herbicidal action | |
| | pyrazo- | against AVEFA | | against POLPE | |
| | sulfuron- | | Calculated | | Calculated |
| 7-pyrazol- | ethyl | | using | | using |
| ylbenzox- | (from | | Colby | | Colby |
| azole I.12 | Group b2) | Found | formula | Found | formula |
| 1.95 | — | 20 | — | 60 | — |
| — | 15.63 | 0 | — | 40 | — |
| 1.95 | 15.63 | 40 | 20 | 95 | 76 |
| 3.91 | — | 30 | — | 65 | — |
| — | 31.25 | 10 | — | 55 | — |
| 3.91 | 31.25 | 50 | 37 | 98 | 84.25 |

### Example 5

### Synergistic Herbicidal Action of the Mixture No. 9.124, Applied by the Post-emergence Method

| Application rate | | Herbicidal action against | |
|---|---|---|---|
| in g/ha | | BIDPI | |
| 7-pyrazolyl- | imazamox | | Calculated using |
| benzoxazole I.9 | (from Group b2) | Found | Colby formula |
| 1.95 | — | 0 | — |
| — | 31.25 | 20 | — |
| 1.95 | 31.25 | 50 | 20 |
| 3.91 | — | 40 | — |
| — | 62.5 | 60 | — |
| 3.91 | 62.5 | 98 | 76 |

### Example 6

### Synergistic Herbicidal Action of the Mixture No. 9.128, Applied by the Post-emergence Method

| Application rate in | | Herbicidal action | | Herbicidal action | |
|---|---|---|---|---|---|
| g/ha | | against COMBE | | against POLPE | |
| | imaze- | | Calculated | | Calculated |
| 7-pyrazol- | thapyr | | using | | using |
| ylbenzox- | (from | | Colby | | Colby |
| azole I.9 | Group b2) | Found | formula | Found | formula |
| 0.98 | — | 10 | — | 10 | — |
| — | 15.63 | 20 | — | 40 | — |
| 0.98 | 15.63 | 50 | 28 | 70 | 46 |
| 1.95 | — | 10 | — | 50 | — |
| — | 31.25 | 40 | — | 60 | — |
| 1.95 | 31.25 | 85 | 46 | 100 | 80 |

### Example 7

### Synergistic Herbicidal Action of the Mixture No. 9.125, Applied by the Post-emergence Method

| | | Herbicidal action | | Herbicidal action | |
|---|---|---|---|---|---|
| Application rate in | | against COMBE | | against POLPE | |
| g/ha | | | Calculated | | Calculated |
| 7-pyrazol- | imazapic | | using | | using |
| ylbenzox- | (from | | Colby | | Colby |
| azole I.9 | Group b2) | Found | formula | Found | formula |
| 0.98 | — | 10 | — | 10 | — |
| — | 15.63 | 0 | — | 75 | — |
| 0.98 | 15.63 | 40 | 10 | 98 | 77.5 |
| 1.95 | — | 10 | — | 50 | — |
| — | 31.25 | 40 | — | 80 | — |
| 1.95 | 31.25 | 90 | 46 | 100 | 90 |

### Example 8

### Synergistic Herbicidal Action of the Mixture No. 9.158, Applied by the Post-emergence Method

| Application rate in | | Herbicidal action | | Herbicidal action | |
|---|---|---|---|---|---|
| g/ha | | against ABUTH | | against POLPE | |
| | bentazone | | Calculated | | Calculated |
| 7-pyrazol- | sodium | | using | | using |
| ylbenzox- | salt (from | | Colby | | Colby |
| azole I.9 | Group b3) | Found | formula | Found | formula |
| 0.49 | — | 0 | — | 5 | — |
| — | 125 | 0 | — | 15 | — |
| 0.49 | 125 | 60 | 0 | 100 | 19.25 |
| 0.98 | — | 70 | — | 10 | — |
| — | 250 | 20 | — | 25 | — |
| 0.98 | 250 | 100 | 76 | 100 | 32.5 |

### Example 9

### Synergistic Herbicidal Action of the Mixture No. 12.140, Applied by the Post-emergence Method

| Application rate | | Herbicidal action against | |
|---|---|---|---|
| in g/ha | | ECHCG | |
| 7-pyrazolyl- | atrazine | | Calculated using |
| benzoxazole I.12 | (from Group b3) | Found | Colby formula |
| 1.95 | — | 50 | — |
| — | 62.5 | 45 | — |
| 1.95 | 62.5 | 98 | 72.5 |
| 3.91 | — | 50 | — |
| — | 125 | 65 | — |
| 3.91 | 125 | 98 | 82.5 |

### Example 10

### Synergistic Herbicidal Action of the Mixture No. 12.152, Applied by the Post-emergence Method

| Application rate | | Herbicidal action against | |
|---|---|---|---|
| in g/ha | | BIDPI | |
| 7-pyrazolyl- | isoproturon | | Calculated using |
| benzoxazole I.12 | (from Group b3) | Found | Colby formula |
| 1.95 | — | 65 | — |
| — | 62.5 | 30 | — |
| 1.95 | 62.5 | 100 | 75.5 |
| 3.91 | — | 65 | — |
| — | 125 | 60 | — |
| 3.91 | 125 | 100 | 86 |

### Example 11

### Synergistic Herbicidal Action of the Mixture No. 12.162, Applied by the Post-emergence Method

| Application rate | | Herbicidal action against | |
|---|---|---|---|
| in g/ha | | AVEFA | |
| 7-pyrazolyl- | paraquat | | Calculated using |
| benzoxazole I.12 | (from Group b3 ) | Found | Colby formula |
| 1.95 | — | 40 | — |
| — | 62.5 | 70 | — |
| 1.95 | 62.5 | 95 | 82 |
| 3.91 | — | 40 | — |
| — | 125 | 80 | — |
| 3.91 | 125 | 95 | 88 |

### Example 12

### Synergistic Herbicidal Action of the Mixture No. 12.213, Applied by the Post-emergence Method

| Application rate | | Herbicidal action against | |
|---|---|---|---|
| in g/ha | | POLPE | |
| 7-pyrazolyl- | clomazone | | Calculated using |
| benzoxazole I.12 | (from Group b5) | Found | Colby formula |
| 0.49 | — | 15 | — |
| — | 125 | 75 | — |
| 0.49 | 125 | 90 | 78.75 |
| 0.98 | — | 15 | — |
| — | 250 | 75 | — |
| 0.98 | 250 | 90 | 78.75 |

### Example 13

### Synergistic Herbicidal Action of the Mixture No. 12.205, Applied by the Post-emergence Method

| Application rate | | Herbicidal action against | |
|---|---|---|---|
| in g/ha | | ECHCG | |
| 7-pyrazolyl- | mesotrione | | Calculated using |
| benzoxazole I.12 | (from Group b5) | Found | Colby formula |
| 0.49 | — | 0 | — |
| — | 7.81 | 45 | — |
| 0.49 | 7.81 | 75 | 45 |
| 0.98 | — | 0 | — |
| — | 15.63 | 70 | — |
| 0.98 | 15.63 | 100 | 70 |

### Example 14

### Synergistic Herbicidal Action of the Mixture No. 12.200, Applied by the Post-emergence Method

| Application rate | | Herbicidal action against | |
|---|---|---|---|
| in g/ha | | SETVI | |
| 7-pyrazolyl- | picolinafen | | Calculated using |
| benzoxazole I.12 | (from Group b5) | Found | Colby formula |
| 0.98 | — | 40 | — |
| — | 15.63 | 40 | — |
| 0.98 | 15.63 | 70 | 64 |
| 1.95 | — | 50 | — |
| — | 15.63 | 40 | — |
| 1.95 | 15.63 | 75 | 70 |

### Example 15

### Synergistic Herbicidal Action of the Mixture No. 9.218, Applied by the Post-emergence Method

| Application rate in g/ha | | | |
|---|---|---|---|
| | glyphosate iso- | Herbicidal action against AVEFA | |
| 7-pyrazolyl- | propylamine salt | | Calculated using |
| benzoxazole I.9 | (from Group b6) | Found | Colby formula |
| 1.95 | — | 10 | — |
| — | 250 | 40 | — |
| 1.95 | 250 | 98 | 46 |
| 3.91 | — | 20 | — |
| — | 250 | 40 | — |
| 3.91 | 250 | 98 | 52 |

### Example 16

### Synergistic Herbicidal Action of the Mixture No. 12.218, Applied by the Post-emergence Method

| Application rate in g/ha | | | |
|---|---|---|---|
| | glyphosate iso- | Herbicidal action against AVEFA | |
| 7-pyrazolyl- | propylamine salt | | Calculated using |
| benzoxazole I.12 | (from Group b6) | Found | Colby formula |
| 1.95 | — | 20 | — |
| — | 250 | 40 | — |
| 1.95 | 250 | 90 | 52 |
| 3.91 | — | 30 | — |
| — | 250 | 40 | — |
| 3.91 | 250 | 90 | 58 |

### Example 17

### Synergistic Herbicidal Action of the Mixture No. 9.219, Applied by the Post-emergence Method

| Application rate in g/ha | | | |
|---|---|---|---|
| | glufosinate | Herbicidal action against BRAPL | |
| 7-pyrazolyl- | ammonium salt | | Calculated using |
| benzoxazole I.9 | (from Group b7) | Found | Colby formula |
| 3.91 | — | 65 | — |
| — | 125 | 45 | — |
| 3.91 | 125 | 100 | 81 |
| 7.81 | — | 85 | — |
| — | 125 | 45 | — |
| 7.81 | 125 | 100 | 92 |

### Example 18

### Synergistic Herbicidal Action of the Mixture No. 12.219, Applied by the Post-emergence Method

| Application rate in g/ha | | | |
|---|---|---|---|
| | glufosinate | Herbicidal action against BRAPL | |
| 7-pyrazolyl- | ammonium salt | | Calculated using |
| benzoxazole I.12 | (from Group b7) | Found | Colby formula |
| 3.91 | — | 60 | — |
| — | 125 | 45 | — |
| 3.91 | 125 | 85 | 78 |
| 7.81 | — | 75 | — |
| — | 125 | 45 | — |
| 7.81 | 125 | 100 | 86 |

### Example 19

### Synergistic Herbicidal Action of the Mixture No. 9.225, Applied by the Pre-emergence Method

| Application rate in g/ha | | Herbicidal action against THLAR | |
|---|---|---|---|
| 7-pyrazolyl- | pendimethalin | | Calculated using |
| benzoxazole I.9 | (from Group b9) | Found | Colby formula |
| 15.63 | — | 80 | — |
| — | 250 | 40 | — |
| 15.63 | 250 | 100 | 88 |
| 31.25 | — | 80 | — |
| — | 250 | 40 | — |
| 31.25 | 250 | 100 | 88 |

### Example 20

### Synergistic Herbicidal Action of the Mixture No. 9.284, Applied by the Post-emergence Method

| | | Herbicidal action | | Herbicidal action | |
|---|---|---|---|---|---|
| Application rate in | | against POAAN | | against MATIN | |
| g/ha | | | Calculated | | Calculated |
| 7-pyrazol- | flufenacet | | using | | using |
| ylbenzox- | (from | | Colby | | Colby |
| azole I.9 | Group b10) | Found | formula | Found | formula |
| 1.95 | — | 10 | — | 20 | — |
| — | 250 | 0 | — | 10 | — |
| 1.95 | 250 | 40 | 10 | 50 | 28 |
| 3.91 | — | 10 | — | 20 | — |
| — | 250 | 0 | — | 10 | — |
| 3.91 | 250 | 50 | 10 | 60 | 28 |

### Example 21

### Synergistic Herbicidal Action of the Mixture No. 12.284, Applied by the Post-emergence Method

| Application rate in g/ha | | Herbicidal action against VERSS | |
|---|---|---|---|
| 7-pyrazolyl- | flufenacet | | Calculated using |
| benzoxazole I.12 | (from Group b10) | Found | Colby formula |
| 0.49 | — | 0 | — |
| — | 250 | 0 | — |
| 0.49 | 250 | 25 | 0 |
| 0.98 | — | 50 | — |
| — | 250 | 0 | — |
| 0.98 | 250 | 70 | 50 |

### Example 22

### Synergistic Herbicidal Action of the Mixture No. 9.250, Applied by the Pre-emergence Method

| Application rate in | | Herbicidal action | | Herbicidal action | |
|---|---|---|---|---|---|
| g/ha | | against ECHCG | | against CHEAL | |
| | dimethen- | | Calculated | | Calculated |
| 7-pyrazol- | amide-P | | using | | using |
| ylbenzox- | (from | | Colby | | Colby |
| azole I.9 | Group b10) | Found | formula | Found | formula |
| 7.81 | — | 10 | — | 75 | — |
| — | 62.5 | 85 | — | 10 | — |
| 7.81 | 62.5 | 100 | 86.5 | 85 | 77.5 |
| 15.63 | — | 35 | — | 75 | — |
| — | 62.5 | 85 | — | 10 | — |
| 15.63 | 62.5 | 100 | 90 | 100 | 77.5 |

### Example 23

### Synergistic Herbicidal Action of the Mixture No. 12.250, Applied by the Pre-emergence Method

| Application rate in | | Herbicidal action | | Herbicidal action | |
|---|---|---|---|---|---|
| g/ha | | against ECHCG | | against SORHA | |
| | dimethen- | | Calculated | | Calculated |
| 7-pyrazol- | amide-P | | using | | using |
| ylbenzox- | (from | | Colby | | Colby |
| azole I.12 | Group b10) | Found | formula | Found | formula |
| 31.25 | — | 0 | — | 30 | — |
| — | 62.5 | 85 | — | 50 | — |
| 31.25 | 62.5 | 100 | 85 | 75 | 65 |
| 62.5 | — | 0 | — | 40 | — |
| — | 62.5 | 85 | — | 50 | — |
| 62.5 | 62.5 | 100 | 85 | 85 | 70 |

### Example 24

### Synergistic Herbicidal Action of the Mixture No. 12.301, Applied by the Post-emergence Method

| | | Herbicidal action | | Herbicidal action | |
|---|---|---|---|---|---|
| Application rate in | | against ECHCG | | against POLPE | |
| g/ha | | | Calculated | | Calculated |
| 7-pyrazol- | quinclorac | | using | | using |
| ylbenzox- | (from | | Colby | | Colby |
| azole I.12 | Group b13) | Found | formula | Found | formula |
| 0.98 | — | 0 | — | 15 | — |
| — | 62.5 | 10 | — | 15 | — |
| 0.98 | 62.5 | 60 | 10 | 45 | 27.75 |
| 1.95 | — | 0 | — | 60 | — |
| — | 125 | 10 | — | 15 | — |
| 1.95 | 125 | 65 | 10 | 98 | 66 |

### Example 25

### Synergistic Herbicidal Action of the Mixture No. 12.308, Applied by the Pre-emergence Method

| Application rate in | | | | | |
|---|---|---|---|---|---|
| g/ha | | Herbicidal action | | Herbicidal action | |
| | diflu- | against ABUTH | | against BIDPI | |
| | fenzopyr | | Calculated | | Calculated |
| 7-pyrazol- | sodium | | using | | using |
| benzox- | salt (from | | Colby | | Colby |
| azole I.12 | Group b14) | Found | formula | Found | formula |
| 62.5 | — | 60 | — | 30 | — |
| — | 62.5 | 10 | — | 40 | — |
| 62.5 | 62.5 | 70 | 64 | 70 | 58 |
| 125 | — | 60 | — | 30 | — |
| — | 125 | 30 | — | 70 | — |
| 125 | 125 | 90 | 72 | 95 | 79 |

### Example 26

### Synergistic Herbicidal Action of the Mixture No. 18.107, Applied by the Post-emergence Method

| Application rate in g/ha | | | |
|---|---|---|---|
| 7-pyrazol- | nico- | Herbicidal action against BIDPI | |
| ylbenzox- | sulfuron | | Calculated using |
| azole I.18 | (from Group b2) | Found | Colby formula |
| 1.95 | — | 60 | — |
| — | 3.91 | 70 | — |
| 1.95 | 3.91 | 100 | 88 |
| 3.91 | — | 60 | — |
| — | 7.81 | 80 | — |
| 3.91 | 7.81 | 100 | 92 |

### Example 27

### Synergistic Herbicidal Action of the Mixture No. 18.121, Applied by the Post-emergence Method

Application rate in g/ha

| | propoxycarba- | |
|---|---|---|
| 7-pyrazol- | zone sodium | Herbicidal action against BIDPI |

| ylbenzox- | salt (from | | Calculated using |
|---|---|---|---|
| azole I.18 | Group b2) | Found | Colby formula |
| 1.95 | — | 60 | — |
| — | 3.91 | 30 | — |
| 1.95 | 3.91 | 75 | 72 |
| 3.91 | — | 60 | — |
| — | 7.81 | 40 | — |
| 3.91 | 7.81 | 100 | 76 |

### Example 28

### Synergistic Herbicidal Action of the Mixture No. 18.300, Applied by the Post-emergence Method

| | | Herbicidal action | | Herbicidal action | |
|---|---|---|---|---|---|
| Application rate in | | against AVEFA | | against BRAPL | |
| g/ha | | | Calculated | | Calculated |
| 7-pyrazol- | dicamba | | using | | using |
| ylbenzox- | (from | | Colby | | Colby |
| azole I.12 | Group b13) | Found | formula | Found | formula |
| 1.95 | — | 20 | — | 50 | — |
| — | 125 | 20 | — | 20 | — |
| 1.95 | 125 | 60 | 36 | 90 | 60 |
| 3.91 | — | 20 | — | 50 | — |
| — | 250 | 20 | — | 20 | — |
| 3.91 | 250 | 75 | 36 | 90 | 60 |

### Example 29

### Synergistic Herbicidal Action of the Mixture No. 15.265, Applied by the Post-emergence Method

| Application rate in g/ha | | | |
|---|---|---|---|
| 7-pyrazol- | | Herbicidal action against GALAP | |
| ylbenzox- | S-metolachlor | | Calculated using |
| azole I.15 | (from Group b10) | Found | Colby formula |
| 0.49 | — | 40 | — |
| — | 125 | 0 | — |
| 0.49 | 125 | 85 | 40 |
| 0.98 | — | 70 | — |
| — | 250 | 20 | — |
| 0.98 | 250 | 98 | 76 |

### Example 30

### Synergistic Herbicidal Action of the Mixture No. 15.270, Applied by the Post-emergence Method

| Application rate in g/ha | | | |
|---|---|---|---|
| | S-metolachlor | | |
| | (from Group | | |
| 7-pyrazol- | b10) + | Herbicidal action against GALAP | |
| ylbenzox- | benzoxacor | | Calculated using |
| azole I.15 | (from Group C) | Found | Colby formula |
| 0.49 | — | 40 | — |
| — | 125 + 6.25 | 0 | — |
| 0.49 | 125 + 6.25 | 80 | 40 |
| 0.98 | — | 70 | — |
| — | 250 + 12.5 | 0 | — |
| 0.98 | 250 + 12.5 | 98 | 70 |

### Example 31

### Synergistic Herbicidal Action of the Mixture No. 15.292, Applied by the Post-emergence Method

| Application rate in | | | | | |
|---|---|---|---|---|---|
| g/ha | | Herbicidal action | | Herbicidal action | |
| | 2,4-D | against BRAPL | | against BIDPI | |
| | dimethyl- | | Calculated | | Calculated |
| 7-pyrazol- | amine salt | | using | | using |
| ylbenzox- | (from | | Colby | | Colby |
| azole I.15 | Group b13) | Found | formula | Found | formula |
| 0.49 | — | 30 | — | 30 | — |
| — | 31.25 | 10 | — | 80 | — |
| 0.49 | 31.25 | 70 | 37 | 95 | 86 |
| 0.98 | — | 75 | — | 40 | — |
| — | 62.5 | 15 | — | 80 | — |
| 0.98 | 62.5 | 90 | 78.75 | 98 | 88 |

### Example 32

### Synergistic Herbicidal Action of the Mixture No. 15.291, Applied by the Post-emergence Method

| | | Herbicidal action | | Herbicidal action | |
|---|---|---|---|---|---|
| Application rate in | | against ECHCG | | against GALAP | |
| g/ha | | | Calculated | | Calculated |
| 7-pyrazol- | isoxaben | | using | | using |
| ylbenzox- | (from | | Colby | | Colby |
| azole I.15 | Group b11) | Found | formula | Found | formula |
| 0.49 | — | 30 | — | 40 | — |
| — | 125 | 0 | — | 0 | — |
| 0.49 | 125 | 50 | 30 | 50 | 40 |
| 0.98 | — | 40 | — | 70 | — |
| — | 250 | 0 | — | 0 | — |
| 0.98 | 250 | 60 | 40 | 90 | 70 |

### Safener Action

As in the example above, test plants were grown, treated with the mixture according to the invention by the Pre-emergence method and, after a test period of 21 days, evaluated using a scale from 0 to 100% damage. The test plants used were crop plants.

A safener action is present if the damage to the crop plant caused by using a mixture according to the invention which comprises a safener C) is less than the damage caused when active compound A or active compounds A and B are used without safener.

### Example 33

### Safener Action of the Mixture No. 12.317, Applied by the Pre-emergence Method

| Application rate in g/ha | | | |
|---|---|---|---|
| 7-pyrazol- | dichlormid | Damage to the crop | Damage to the crop |
| ylbenzox- | (from | plant corn (ZEAMX), | plant corn (ZEAMX), |
| azole I.12 | Group c) | cultivar Magister | cultivar P3751 |
| 62.5 | — | 38 | 28 |
| — | 100 | 13 | 0 |
| 62.5 | 100 | 5 | 3 |
| 125 | — | 35 | 35 |
| — | 100 | 13 | 0 |
| 125 | 100 | 5 | 5 |

1. A herbicidally active composition comprising
A) at least one 7-pyrazolylbenzoxazole compound of the formula I, 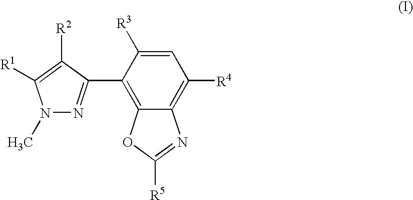
in which the variables R¹-R⁵ are as defined below:
R¹ is difluoromethoxy, trifluoromethyl or methylsulfonyl;
R² is halogen;
R³ is hydrogen or halogen;
R⁴ is halogen or cyano;
R⁵ is hydrogen, C₁-C₆-alkyl, C₁-C₆-haloalkyl, C₃-C₆-alkenyl, cyano-C₃-C₆-alkenyl, C₃-C₆-haloalkenyl, C₃-C₆-alkynyl, cyano-C₃-C₆-alkynyl, C₃-C₆-haloalkynyl,
C₁-C₄-alkyl which carries one of the following groups: cyano, hydroxyl, carboxyl, C₁-C₄-alkoxy, C₁-C₄-haloalkoxy, C₃-C₄-alkenyloxy, C₃-C₄-alkynyloxy, C₃-C₈-cycloalkyl, C₃-C₈-cycloalkyloxy, amino, C₁-C₄-alkylamino, di(C₁-C₄-alkyl)amino, C₁-C₄-alkylthio, C₁-C₄-haloalkylthio, C₃-C₄-alkenylthio, C₃-C₄-alkynylthio, C₁-C₄-alkylsulfinyl, C₁-C₄-haloalkylsulfinyl, C₃-C₄-alkenylsulfinyl, C₃-C₄-alkynylsulfinyl, C₁-C₄-alkylsulfonyl, C₁-C₄-haloalkylsulfonyl, C₃-C₄-alkenylsulfonyl, C₃-C₄-alkynylsulfonyl, (C₁-C₄-alkoxy)carbonyl, C₃-C₈-cycloalkyl, phenyl;
phenyl, C₃-C₈-cycloalkyl, where each cycloalkyl or phenyl ring may be unsubstituted or may carry one, two, three or four substituents independently of one another selected from the group consisting of cyano, nitro, amino, hydroxyl, carboxyl, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, (C₁-C₄-alkoxy)carbonyl, (C₁-C₄-alkyl)carbonyl, (C₁-C₄-haloalkyl)carbonyl, (C₁-C₄-alkyl)carbonyloxy, (C₁-C₄-haloalkyl)carbonyloxy and di(C₁-C₄-alkyl) amino;
and/or at least one of its agriculturally acceptable salts; and
at least one further active compound selected from
B) herbicides of classes b1) to b15):
b1) lipid biosynthesis inhibitors;
b2) acetolactate synthase inhibibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitose inhibitors;
b10)inhibitors of the synthesis of long-chain fatty acids (VLCFA inhibitors);
b11) cellulose biosynthesis inhibitors;
b12) decoupler herbicides;
b13) auxin herbicides;
b14) auxin transport inhibitors;
b15) other herbicides selected from the group consisting of benzoylprop, flamprop, flamprop-M, bromobutide, chlorflurenol, cinmethylin, methyldymuron, etobenzanid, fosamine, metam, pyributicarb, oxaciclomefone, dazomet, daimuron (dymron), cumyluron, triaziflam and methyl bromide; and
C) safeners selected from: benoxacor, cloquintocet, cyometrinil, dichlormid, dicyclonon, dietholate, fenchlorazole, fenclorim, flurazole, fluxofenim, furilazole, isoxadifen, mefenpyr, mephenate, napthalic anhydride, 2,2,5-trimethyl-3-(dichloroacetyl)-1,3-oxazolidine, 4-(dichloroacetyl)-1-oxa-4-azaspi-ro[4.5]decane and oxabetrinil,
the agriculturally acceptable salts of the active compounds B and C and the agriculturally acceptable derivatives of the active compounds B and C, provided they have a carboxyl group.

2. A composition as claimed in claim 1 where the variables R¹ to R⁵ in formula I are as defined below:
R¹ is difluoromethoxy;
R² is chlorine or bromine;
R³ is hydrogen, fluorine or chlorine;
R⁴ is halogen or cyano;
R⁵ is hydrogen, C₁-C₆-alkyl, C₁-C₆-haloalkyl, C₁-C₄-alkoxy-C₁-C₄-alkyl, C₃-C₆-alkenyl, C₃-C₆-alkynyl, C₃-C₇-cycloalkyl, C₃-C₈-cycloalkyl-C₁-C₄-alkyl, phenyl or benzyl.

3. A composition as claimed in claim 2 where the variables R³ to R⁴ in formula I are as defined below:
R³ is fluorine or chlorine;
R⁴ is chlorine.

4. A composition as claimed in claim 2 where R⁵ is C₁-C₄-alkyl, cyclopropyl or cyclopropylmethyl.

5. A composition as claimed in claim 1, comprising at least one herbicide B selected from the compounds listed below:
b1) from the group of the lipid biosynthesis inhibitors: chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate and bensulide;
b2) from the group of the ALS inhibitors: amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;
b3) from the group of the photosynthesis inhibitors: atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine, terbutryne, trietazine, ametridione, amibuzin, hexazinone, isomethiozin, metamitron, metribuzin, bromacil, isocil, lenacil, terbacil, brompyrazon, chloridazon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluron, anisuron, buturon, chlorbromuron, chloreturon, chlorotoluron, chloroxuron, difenoxuron, dimefuron, diuron, fenuron, fluometuron, fluothiuron, isoproturon, linuron, methiuron, metobenzuron, metobromuron, metoxuron, monolinuron, monuron, neburon, parafluron, phenobenzuron, siduron, tetrafluron, thidiazuron, cyperquat, diethamquat, difenzoquat, diquat, morfamquat, paraquat, bromobonil, bromoxynil, chloroxynil, iodobonil, ioxynil, amicarbazone, bromofenoxim, flumezin, methazole, bentazone, propanil, pentanochlor, pyridate, and pyridafol;
b4) from the group of the protoporphyrinogen-IX oxidase inhibitors: acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen, etnipromid and phenyluracil compounds of the formula II 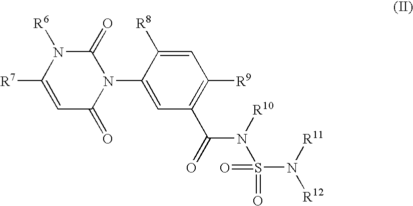
in which the variables R⁶-R¹² are as defined below:
R⁶ is methyl or NH₂;
R⁷ is C₁-C₂-haloalkyl;
R⁸ is hydrogen or halogen;
R⁹ is halogen or cyano;
R¹⁰ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or alkyl;
R¹¹, R¹² independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl, where each of the 8 last-mentioned substituents is unsubstituted or may be substituted by 1 to 6 halogen atoms and/or by one, two or three groups selected from: OH, NH₂, CN, CONH₂, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, C₁-C₄-alkylamino, di-(C₁-C₄-alkyl)amino, formyl, C₁-C₄-alkylcarbonyl, C₁-C₄-alkoxycarbonyl, C₁-C₄-alkylaminocarbonyl, di(C₁-C₄-alkyl)aminocarbonyl, C₃-C₇-cycloalkyl, phenyl or benzyl; or
R¹¹, R¹² together with the nitrogen atom form a 3-, 4-, 5-, 6- or 7-membered saturated or unsaturated nitrogen heterocycle which is unsubstituted or substituted by 1 to 6 methyl groups and which may contain, as ring members, 1 or 2 further heteroatoms selected from the group consisting of nitrogen, oxygen and sulfur,
b5) from the group of the bleacher herbicides: metflurazon, norflurazon, flufenican, diflufenican, picolinafen, beflubutamid, fluridone, flurochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoro methylphenoxy)-2-(4-trifluoromethylphenyl)pyrimidine and also 3-heterocyclyl-substituted benzoyl derivatives of the formula III 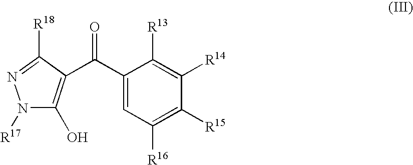
in which the variables R¹³ to R¹⁸ are as defined below:
R¹³, R¹⁵ are hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl;
R¹⁴ is a heterocyclic radical selected from the group consisting of: thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, where the nine radicals mentioned may be unsubstituted or mono- or polysubstituted by halogen, C₁-C₄-alkyl, C₁-C₄-alkoxy, C₁-C₄-haloalkyl, C₁-C₄-haloalkoxy or C₁-C₄-alkylthio;
R¹⁶ is hydrogen, halogen or C₁-C₆-alkyl;
R¹⁷ is C₁-C₆-alkyl;
R¹⁸ is hydrogen or C₁-C₆-alkyl;
b6) from the group of the EPSP synthase inhibitors: glyphosate;
b7) from the group of the glutamine synthase inhibitors: glufosinate and bilanaphos;
b8) from the group of the DHP synthase inhibitors: asulam;
b9) from the group of the mitose inhibitors: benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, chlorthal, carbetamide, chlorbufam, chlorpropham and propham;
b10) from the group of the VLCFA inhibitors: acetochlor, alachlor, butachlor, butenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane;
b11) from the group of the cellulose biosynthesis inhibitors: dichlobenil, chlorthiamid, isoxaben and flupoxam;
b12) from the group of the decoupler herbicides: dinofenate, dinoprop, dinosam, dinoseb, dinoterb, DNOC, etinofen and medinoterb;
b13) from the group of the auxin herbicides: clomeprop, 2,4-D, 2,4,5-T, MCPA, MCPA-thioethyl, dichlorprop, dichlorprop-P, mecoprop, mecoprop-P, 2,4-DB, MCPB, chloramben, dicamba, 2,3,6-TBA, tricamba, quinclorac, quinmerac, clopyralid, fluroxypyr, picloram, triclopyr and benazolin;
b14) from the group of the auxin transport inhibitors: naptalam, diflufenzopyr;
b15) from the group of other herbicides: benzoylprop, flamprop, flamprop-M, bromobutide, chlorflurenol, cinmethylin, methyldymron, etobenzanid, fosamine, metam, pyributicarb, oxaziclomefone, dazomet, triaziflam, methyl bromide, daimuron (dymron) and cumyluron;
the agriculturally acceptable salts and the agriculturally acceptable derivatives of the herbicides B, provided they have a carboxyl group.

6. A composition as claimed in claim 5 where the herbicides B are selected from:
b1) clodinafop, cyhalofop, diclofop, fenoxaprop, fenoxaprop-P, fluazifop, fluazifop-P, haloxyfop, haloxyfop-P, metamifop, quizalofop, quizalofop-P, alloxydim, butroxydim, clethodim, cloproxydim, cycloxydim, profoxydim, sethoxydim, tepraloxydim, tralkoxydim;
b2) amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, propoxycarbazone, flucarbazone, imazamethabenz, imazamox, imazapic, imazapyr, imazaquin, imazethapyr, cloransulam, diclosulam, florasulam, flumetsulam, metosulam, penoxsulam, bispyribac, pyribenzoxim, pyriftalid, pyrithiobac, pyriminobac;
b3) atrazine, cyanazine, simazine, terbuthylazine, hexazinone, metamitron, metribuzin, amicarbazone, chloridazon, chlorbromuron, chlorotoluron, diuron, isoproturon, linuron, methabenzthiazuron, propanil, bromoxynil, ioxynil, bentazone, pyridate, difenzoquat, diquat, paraquat;
b4) acifluorfen, fluoroglycofen, halosafen, lactofen, oxyfluorfen, fluazolate, pyraflufen, cinidon-ethyl, flumiclorac, flumioxazin, fluthiacet, oxadiazon, oxadiargyl, azafenidin, carfentrazone, sulfentrazone, pentoxazone, benzfendizone, butafenacil, pyraclonil, profluazol, flufenpyr, nipyraclofen, 2-chloro-5-[3,6-dihydro-3-methyl-2,6-dioxo-4-(trifluoromethyl)-1(2H)-pyrimidinyl]-N-(dimethylsulfamoyl)-4-fluorobenzamide, 5-[3-amino-3,6-dihydro-2,6-dioxo-4-(trifluoromethyl)-1(2H)-pyrimidinyl]-2-chloro-N-(dimethylsulfamoyl)-4-fluorobenzamide, 2-chloro-5-[3,6-dihydro-3-methyl-2,6-dioxo-4-(trifluoromethyl)-1(2H)-pyrimidinyl]-N-[(ethyl)methylsulfamoyl]-4-fluorobenzamide, 5-[3-amino-3,6-dihydro-2,6-dioxo-4-(trifluoromethyl)-1(2H)-pyrimidinyl]-2-chloro-N-[(ethyl)methylsulfamoyl]-4-fluorobenzamide, 2-chloro-5-[3,6-dihydro-3-methyl-2,6-dioxo-4-(trifluoromethyl)-1(2H)-pyrimidinyl]-4-fluoro-N-[(methyl)propylsulfamoyl]benzamide, 5-[3-amino-3,6-dihydro-2,6-dioxo-4-(trifluoromethyl)-1(2H)-pyrimidinyl]-2-chloro-4-fluoro-N-[(methyl)propylsulfamoyl]benzamide, 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]benzamide, 5-[3-amino-3,6-dihydro-2,6-dioxo-4-(trifluoromethyl)-1(2H)-pyrimidinyl]-2-chloro-4-fluoro-N-[(isopropyl)methylsulfamoyl]benzamide, N-[(butyl)methylsulfamoyl]-2-chloro-5-[3,6-dihydro-3-methyl-2,6-dioxo-4-(trifluoromethyl)-1(2H)-pyrimidinyl]-4-fluorobenzamide, 5-[3-amino-3,6-dihydro-2,6-dioxo-4-(trifluoromethyl)-1(2H)-pyrimidinyl]-N-[(butyl)methylsulfamoyl]-2-chloro-4-fluorobenzamide, 2-chloro-5-[3,6-dihydro-3-methyl-2,6-dioxo-4-(trifluoromethyl)-1(2H)-pyrimidinyl]-4-fluoro-N-[(isobutyl)methylsulfamoyl]benzamide, 5-[3-amino-3,6-dihydro-2,6-dioxo-4-(trifluoromethyl)-1(2H)-pyrimidinyl]-2-chloro-4-fluoro-N-[(isobutyl)methylsulfamoyl]benzamide, 2-chloro-5-[3,6-dihydro-3-methyl-2,6-dioxo-4-(trifluoromethyl)-1(2H)-pyrimidinyl]-N-(dimethylsulfamoyl)benzamide, 5-[3-amino-3,6-dihydro-2,6-dioxo-4-(trifluoromethyl)-1(2H)-pyrimidinyl]-2-chloro-N-(dimethylsulfamoyl)benzamide, 2-chloro-5-[3,6-dihydro-3-methyl-2,6-dioxo-4-(trifluoromethyl)-1(2H)-pyrimidinyl]-N-[(ethyl)methylsulfamoyl]benzamide, 5-[3-amino-3,6-dihydro-2,6-dioxo-4-(trifluoromethyl)-1(2H)-pyrimidinyl]-2-chloro-N-[(ethyl)methylsulfamoyl]benzamide, 2-chloro-5-[3,6-dihydro-3-methyl-2,6-dioxo-4-(trifluoromethyl)-1(2H)-pyrimidinyl]-N-[(methyl)propylsulfamoyl]benzamide, 5-[3-amino-3,6-dihydro-2,6-dioxo-4-(trifluoromethyl)-1(2H)-pyrimidinyl]-2-chloro-N-[(methyl)propylsulfamoyl]benzamide, 2-chloro-5-[3,6-dihydro-3-methyl-2,6-dioxo-4-(trifluoromethyl)-1(2H)-pyrimidinyl]-N-[(isopropyl)methylsulfamoyl]benzamide, 5-[3-amino-3,6-dihydro-2,6-dioxo-4-(trifluoromethyl)-1(2H)-pyrimidinyl]-2-chloro-N-[(isopropyl)methylsulfamoyl]benzamide, N-[(butyl)methylsulfamoyl]-2-chloro-5-[3,6-dihydro-3-methyl-2,6-dioxo-4-(trifluoromethyl)-1(2H)-pyrimidinyl]benzamide, 5-[3-amino-3,6-dihydro-2,6-dioxo-4-(trifluoromethyl)-1(2H)-pyrimidinyl]-N-[(butyl)methylsulfamoyl]-2-chlorobenzamide, 2-chloro-5-[3,6-dihydro-3-methyl-2,6-dioxo-4-(trifluoromethyl)-1(2H)-pyrimidinyl]-N-[(isobutyl)methylsulfamoyl]benzamide, 5-[3-amino-3,6-dihydro-2,6-dioxo-4-(trifluoromethyl)-1(2H)-pyrimidinyl]-2-chloro-N-[(isobutyl)methylsulfamoyl]benzamide,
b5) norflurazon, diflufenican, picolinafen, beflubutamid, fluridone, flurochloridone, flurtamone, mesotrione, sulcotrione, isoxachlortole, isoxaflutole, benzofenap, pyrazolynate, pyrazoxyfen, benzobicyclon and clomazone, and also [2-chloro-3-(4,5-dihydro-3-isoxazolyl)-4-(methylsulfonyl)phenyl](5-hydroxy-1-methyl-1H-pyrazol-4-yl)methanone, [3-(4,5-dihydro-3-isoxazolyl)-2-methyl-4-(methylsulfonyl)phenyl](5-hydroxy-1-methyl-1H-pyrazol-4-yl)methanone, [2-chloro-3-(3-methyl-5-isoxazolyl)-4-(methylsulfonyl)phenyl](5-hydroxy-1-methyl-1H-pyrazol-4-yl)methanone, (5-hydroxy-1-methyl-1H-pyrazol-4-yl)[2-methyl-3-(3-methyl-5-isoxazolyl)-4-(methylsulfonyl)phenyl]methanone, and also 4-(3-trifluoromethylphenoxy)-2-(4-trifluoromethylphenyl)pyrimidine;
b6) glyphosate;
b7) glufosinate;
b9) benfluralin, butralin, dinitramine, ethalfluralin, oryzalin, pendimethalin, trifluralin, propyzamide;
b10)acetochlor, alachlor, butachlor, dimethenamid, dimethenamid-P, metazachlor, metolachlor, S-metolachlor, henylchlor, flufenacet, mefenacet, fentrazamide, cafenstrole, indanofan;
b11) dichlobenil, chlorthiamid, isoxaben, flupoxam;
b13)2,4-D, 2,4-DB, dichlorprop, dichlorprop-P, MCPA, MCPB, mecoprop, mecoprop-P, dicamba, quinclorac, quinmerac, clopyralid, fluroxypyr, picloram, triclopyr, benazolin;
b14) diflufenzopyr;
b15) bromobutide, cinmethylin, methyldymron, oxaziclomefone, triaziflam, daimuron (dymuron) and cumyluron;
the agriculturally acceptable salts of the abovementioned active compounds B and the agriculturally acceptable derivatives of the active compounds B, provided they have a carboxyl group.

7. A composition as claimed in claim 1, comprising at least one safener C selected from the group consisting of benoxacor, cloquintocet, dichlormid, fenchlorazole, fenclorim, fluxofenim, furilazole, isoxadifen, mefenpyr, 2,2,5-trimethyl-3-(dichloroacetyl)-1,3-oxazolidine, 4-(dichloroacetyl)-1-oxa-4-azaspiro[4.5]decane and oxabetrinil, their agriculturally acceptable salts and, in the case of carboxylic acids, their agriculturally acceptable derivatives.

8. A composition as claimed in claim 1 where the weight ratio of component A to component B is in the range from 10:1 to 1:500.

9. A composition as claimed in claim 1 where the weight ratio of component A to component C is in the range from 10:1 to 1:10.

10. A composition as claimed in claim 1 where the weight ratio of component B to component C is in the range from 50:1 to 1:10.

11. A composition as claimed in claim 1, comprising, as active compound A), a 7-pyrazolylbenzoxazole compound of the formula I in which R¹ is difluoromethoxy, R² is chlorine or bromine, R³ is fluorine or chlorine, R⁴ is Cl and R⁵ is C₁-C₄-alkyl, and, as active compound B), a compound selected from the group consisting of tepraloxydim, profoxydim, cyhalofop, sethoxydim, cyclosulfamuron, pyrazosulfuron, imazamox, imazethapyr, imazapic, imazapyr, imazaquin, nicosulfuron, propoxycarbazone, dicamba, bentazone, atrazine, isoproturon, paraquat, clomazone, mesotrione, picolinafen, glyphosate, glufosinate, acetochlor, S-metalochlor, brombutide, methyldymron, oxaziclomefone, daimuron, cumyluron, pendimethalin, flufenacet, dimethenamid-P, isoxaben, 2,4-D, quinclorac and diflufenzopyr and, in the case of ionizable or ionic herbicides, also their salts, and, in the case of compounds having a carboxyl group, also their derivatives.

12. A composition as claimed in claim 1 in the form of a crop protection composition comprising additionally at least one inert liquid and/or solid carrier, if desired at least one surfactant and, if appropriate, customary auxiliaries.

13. A composition as claimed in claim 1 in the form of a crop protection composition formulated as a 2-component composition comprising a first component comprising the active compound A, a solid or liquid carrier and, if appropriate, one or more surfactants, and a second component comprising at least one further active compound selected from among the herbicides B and the safeners C, a solid or liquid carrier and, if appropriate, one or more surfactants.

14. A method for controlling unwanted vegetation, which comprises applying a herbicidally effective amount of a composition as claimed in claim 1 to plants, to their habitat or to seed.

15. A method as claimed in claim 14 which comprises applying the before, during and/or after the emergence of the unwanted plants, where the herbicidally effective components A), B) and C) are applied simultaneously or in succession.

16. A method as claimed in claim 15, wherein the leaves of the crop plants and of the unwanted plants are treated.

17. (canceled)

18. The method as claimed in claim 14 for controlling undesirable vegetation in crops of cereals.

19. The method as claimed in claim 14 for controlling undesirable vegetation in crops of corn and in crops of sorghum.

20. The method as claimed in claim 14 for controlling undesirable vegetation in crops of rice.

21. The method as claimed in claim 14 for controlling undesirable vegetation in crops of cotton, in crops of oilseed rape, in crops of soyabean, in crops of potatoes, in crops of dry beans, in crops of groundnuts and in perennial crops.

22. The method as claimed in claim 14 for controlling undesirable vegetation in forestry.

23. The method as claimed in claim 14 for controlling undesirable vegetation in crops of plants where the crop plants are resistant to one or more herbicides owing to genetical engineering and/or breeding.

24. The method as claimed in claim 14 for controlling undesirable vegetation in crops of plants where the crop plants are resistant to attack by insects owing to genetical engineering and/or breeding.

25. A method for the desiccation and/or defoliation of plants, which comprises applying a herbicidally effective amount of a herbicidal mixture as claimed in claim 1 to plants, to their habitat or to seed.
